(19) United States
(12) Patent Application Publication
(10) Pub. No.: US 2004/0128155 A1
(43) Pub. Date: Jul. 1, 2004

(54) System and method for resolving a dispute in electronic commerce and managing an online dispute resolution process

(76) Inventors: Lalitha Vaidyanathan, San Francisco, CA (US); John Quinn, San Francisco, CA (US); Ahmed Khaishgi, San Francisco, CA (US); Cara Cherry-Lisco, San Francisco, CA (US)

Correspondence Address: SHUMAKER & SIEFFERT, P. A., 8425 SEASONS PARKWAY, SUITE 105, ST. PAUL, MN, 55125, US

(21) Appl. No.: 10/634,654

(22) Filed: Aug. 5, 2003

Related U.S. Application Data
(63) Continuation-in-part of application No. 09/504,159, filed on Feb. 15, 2000.
(60) Provisional application No. 60/469,502, filed on May 9, 2003.

(51) Int. Cl. G06F 17/60

(52) U.S. Cl. 705/1; 705/80

(57) ABSTRACT

Techniques are described for handling disputes online. The techniques particularly relate to high-volume dispute handling, and integration with an online marketplace or general online selling. The techniques can handle a very high volume of concurrent disputes cost effectively, and provide for the central management of a large and geographically distributed group of dispute resolution specialists that assist with online dispute resolution. The techniques address needs arising through the recent growth of global online marketplaces and online selling.

This application is a Continuation-in-part of Ser. No. 09/504,159, filed Feb. 15, 2000, and claims priority to U.S. Provisional Patent Application Serial No. 60/469,502, filed May 9, 2003, the entire contents of which are incorporated herein by reference.

### TECHNICAL FIELD

This invention relates to systems and methods of dispute resolution and, more particularly, to systems and methods of online dispute resolution in electronic commerce.

### BACKGROUND

The proliferation of electronic commerce using the Internet as a common communication medium has established a need for an effective dispute resolution mechanism when exchanges in electronic commerce are unsatisfactory to one or more the parties involved. The Internet is a convenient medium by which consumers and businesses can purchase a variety of goods and services. Typically, a customer selects a product or service from a seller over the Internet, such as from a web site or in an online marketplace, and completes the transaction electronically, all except for the delivery of the goods or the services. Since buyers and sellers meet online, convenience of selecting, ordering and payment is offset by the possibility of the transaction not occurring as planned and the difficulty in resolving any issues post-order. Issues could include unscrupulous merchants, a failure to deliver the goods or services promised, a lack of quality in the goods or services which are delivered or other ways in which one of the two parties feels that the transaction did not occur as expected. The difficulty of resolving an issue once it occurs is compounded by the fact that the parties are in different locations and therefore, cannot show one another visually what may be the issue, or cannot discuss face to face other alternatives that may lead to mutual satisfaction. All these factors also contribute to a general lack of trust between parties. Hence, without an adequate system, parties are often left highly dissatisfied with the electronic commerce experience with a common outcome of not participating as much or at all due to the risks or due to an incidence of real or perceived dispute.

Traditional dispute resolution processes do not provide an effective solution. The traditional court system is expensive to use and the system may deny justice to those who cannot afford the expense or those with claims too small to justify the expense. Further, the traditional court system does not effectively notify others in electronic commerce neither of the complaints involved in the dispute nor of the resolution of the dispute. Thus, the traditional court system fails to increase trust between buyers and sellers electronic commerce in which on anonymity prevails. Moreover, the traditional legal system is based on geographic jurisdiction and, thus, is not effective in dealing with cross-border or cross-state or often times cross-locality transactions that may occur in electronic commerce. Further traditional systems are generally slow and very procedural.

Other processes involving governmental or nonprofit consumer organizations, such as the Better Business Bureau, provide services to consumers involved in disputed transactions whether those transactions are traditional or electronic. However, these processes are often not readily accessible to consumers in electronic commerce are slow, based on postal mail and limited geographically to regions where such organizations have physical offices.

### SUMMARY OF THE INVENTION

In general, techniques are described for handling disputes online. The techniques particularly relate to high-volume dispute handling, and integration with an online marketplace or general online selling. The techniques can handle a very high volume of concurrent disputes cost effectively, and provide for the central management of a large and geographically distributed group of dispute resolution specialists that assist with online dispute resolution. The techniques address needs arising through the recent growth of global online marketplaces and online selling.

The described techniques allow dispute resolution to take a much broader definition and value in e-commerce settings than traditional forms of alternative dispute resolution (ADR) have played in the offline world. In offline settings ADR is generally limited to the use of mediation or arbitration only once a problem has escalated to a relatively escalated and damaging level, whereas the techniques described herein apply online dispute resolution (“ODR”) processes much earlier, much more broadly and much more positively in nature, as described below, to de-escalate and resolve disputes. Moreover, the techniques may present ODR as part of the trust building and safety attributes of an online marketplace.

According to the principles of the invention, an ODR system applies the described techniques to help capture an issue and route it to the appropriate ODR module. The ODR modules may apply processes that span far beyond traditional dispute resolution mechanisms, such as automated complaint handling, automated direct negotiation between the parties, automated agreement processes, facilitated case handling, facilitated mediation, specialized mediation processes (e.g., feedback removal) and specific marketplace processes (further elaborated below).

The techniques can also support the varying nature of online marketplaces in a dynamic fashion. According to one aspect of the invention, the processes can vary by sub-marketplace, for example dispute resolution processes available for addressing a car purchase on eBay motors is different than for general merchandise such as clothing. The ODR system can be accessed directly from the sub-marketplace, or might route the case to different processes based on recognizing the different transaction type. In another aspect, other marketplace specific dispute resolution processes might include automatically routing cases to internal fraud claims handling, online payment system disputes, and third party integration such as with an insurance company handling car disputes.

Online marketplaces also have distinct needs for a recourse or dispute resolution process to support online reputation systems, for example the feedback forum in eBay's online marketplace. While the reputations served as an enforcement mechanism to reward or punish the other party for an effective transaction, they lacked a neutral, effective means to provide dispute resolution before leaving such feedback or to resolve disputes that might include retraction of negative or positive feedback. Hence, techniques described herein serve a new need in providing recourse to support online reputation systems, in a way that traditional dispute resolution could not have easily solved. Sellers' or buyers' ability to effectively transact is dramatically impacted by their reputation rating, making ODR a new important function required to neutrally address the repair of unfair reputation marks or to resolve issues that would otherwise have incurred negative feedbacks without use of ODR. Similarly, sellers or buyers may want to retract prematurely placed positive feedback once they complete a transaction and become dissatisfied with a transaction, thereby ensuring the validity of positive reputations in the reputation system.

Further, the described techniques provide a comprehensive ODR system that may be tailored to, and integrated within, an online marketplace. Because a dispute rarely is solely about feedback, the need for a comprehensive ODR solution is important, to solve the underlying dispute (e.g., poor service, damaged goods, refund) or to record both parties' agreement to resolve the dispute or to record that one of the parties did not participate in the ODR solution, in context with correcting or preventing the posting of a negative feedback. The techniques described herein allow automated or manually assisted processes to address feedback or reputation related disputes in context of an online marketplace. The ODR system can automatically route a dispute to specialized processes when detecting that feedback is a component of the issue under dispute.

The techniques described herein also allow automated communication with the marketplace when a reputation dispute has been settled in order to correct the feedback rating or allow a fully integrated data system of ODR and reputation rating systems. Automated follow-up checks may be used to ensure that the feedback marks have been corrected in a timely fashion. All the systems are designed to rapidly correct reputation. This may reduce the time that someone's reputation is damaged (through a bad feedback) and limit the extent of reputation damage for parties involved on their current and future sales activity.

Moreover, the techniques described herein can proactively alert parties when a negative feedback has been left by another party, and then give the party easy access to the ODR system to help address the dispute. This represents another means of helping parties respond as quickly as possible to reputation damage and the associated dispute in order to correct the issue while it is still current and topical in the minds of both parties and to help reduce the time period or extent of reputation damage.

The techniques described herein may provide new technology, online user interface processes, and the ease of data sharing and system integration to advance the capabilities of dispute resolution processes in an online setting. These allow the ODR system described herein to automatically tailor a dispute resolution experience for users or user types with given sets of issues. As a result, the ODR system can better customize a dispute process based upon such factors as issue type, marketplaces type, and key attributes of both users. With this information, the ODR system can better route disputes in an automated or manual fashion, in some cases flagging key information to facilitate the process. This information can be provided by the users or can be automatically extracted from the online marketplace's database. As with prior inventions of this claim, systems can draw on precedence from similar cases in a similar marketplace and other correlating factors. This is further facilitated by data integration with an online marketplace to automatically check transaction details and in some cases automatically populate online forms with key information. This integration can allow more relevant, accurate and seamless case development.

According to another aspect of the invention, techniques are described for utilizing user information, including processes that identify: repeat users of the online dispute resolution system, users who are high-volume sellers or buyers in the marketplace, and users who have made certain pre-commitments (such as Seal members). Based on this information, the ODR system can create automated messaging to the users and channel them into different dispute handling processes. These users might require special attention due to their value to the marketplace and or due to their pre-commitments (for example commitment to participate in online dispute resolution). Further, the ODR system may customize messaging and processes such that repeat users are addressed with tailored language as compared to introductory language to new users of online dispute resolution who are less familiar with processes. Similarly, repeat users, or users who have pre-committed to using the ODR system, may need to provide less information when filing a case again, as much of their personal information may be on file with the dispute resolution provider. This may be beneficial in an online marketplace setting where dispute resolution is a more familiar and repeatedly used utility, rather than a rarely or never used service such as the court system or mediation in the offline world.

Based on capturing and utilizing user and issue type information, the described ODR processes can also automatically or manually assign these users to a specific pool of dispute resolution specialists (DRS). These specialized cases or pool of specialists can be required to meet different standards as appropriate to the user of the service. For example this might enable higher quality or more attentive communications with repeat or high volume users of ODR or high volume users of an online marketplace. The ODR system can also provide visual clues to the DRS or DRS administrators such that they can more appropriately and quickly communicate with these users. For example, the ODR system might highlight to the DRS the history of cases that the user has been involved in, the level of feedback or marketplace activity of the user, or indication of whether the user is a member of a seller verification or seal program (where the user has pre-committed to specific performance standards). As a result, the ODR system may be able to respond to new needs in online marketplaces, and enable assignment and case development as never before possible or required in traditional methods of dispute resolution.

According to another aspect of the invention, the described ODR system may further automate processes to create a better user experience for both parties. For example, the ODR system may identify when payment is likely to be required for a dispute resolution process and can request that payment be authorized during the initial filing process. This process helps limit unnecessary steps or repeated contact with parties that can otherwise diminish participation or slow down the process. Other automated processes seek to get both parties' “buy-in” to participate before routing a case to a specific process. This can be achieved by recognizing certain processes will likely be required, for example feedback removal mediation, and asking the parties' willingness to participate as part of the filing or initial response process. These automated steps avoid moving parties pre-maturely to a step where one of the parties is not prepared to participate. Otherwise this can lead to disappointment and added time to resolve the dispute. Hence automated processes serve as effective self-service case administration mechanisms helping to better handle high volume disputes as never conducted before.

In another aspect, the techniques provide display functionality that allows sellers to easily display their selling policies and pre-commitments on their online marketplace listings, through their electronic seal (or equivalent graphic display) or other means to further help entities better build trust with their bidders and buyers. The functionality provides better customer support and can avoid disputes in online selling, particularly in online marketplaces. The functionality enables easy creation and display of policies. The ODR system can operate in association with a seal program system, and can include a policy creation wizard-like tool for entities to easily, and at varying degrees of detail, customize their policies, drawing from standardized choices based on best practices in online marketplaces where used (e.g., eBay). The functionality allows sellers to display their policies and pre-commitments (such as to online dispute resolution) in multiple forms to integrate into their selling practices in online marketplaces in an easily repeatable method, including: 1) automatically posting the policies on individual item listings (e.g., on auction listing), 2) allowing bidders to view policies and pre-commitments by clicking on the seller's seal (or equivalent graphic display), 3) delivering their policies and pre-commitments in post-purchase communications between entity and buyer, so that buyer is reminded of what to expect and provided with clear instructions should there be issues (e.g., providing a link to an online dispute resolution system), and 4) seamlessly providing this information to mediators if a dispute arises. An entity's polices and pre-commitments may be centrally stored and can be easily modified for repeated or varied use. The functionality allows entities to present policies in a condensed and accessible manner, while giving buyers the ability to learn more details by clicking on individual polices. The listing of the selling policies and pre-commitments reduces the risk of buyers transacting with a particular online merchant by allowing buyers to see the entity's policies in advance of purchase or easily find policies should an issue occur later.

The ODR techniques described herein may offer advantages over conventional techniques. For example, in addition to increasing the ease to the user experience, the techniques may also make it possible to manage high volume disputes in a cost effective manner. Some exemplary techniques described herein include the automation of: issue identification, resolution identification, payment collection, user identification, messaging to parties, requests for participation, self-service direct negotiation and compromise tools, and assignment to DRS or DRS pool. Other new innovations relate to enhanced tools to manage dispute resolution specialists.

In addition, the online mediation and related processes described herein allow centralized resolution management of disputes that can be handled by a highly decentralized group of dispute resolution specialists (e.g., mediators or customer support staff around the world can handle disputes regardless of proximity). Cost effective centralized management is made possible through an online interface presented by the ODR system that provides a set of tools to train the specialists, assign and manage the processes, and maintain global quality control of the processes. Other described techniques that aid the central management of disputes and dispute resolution specialists (DRS) include automatically or manually channeling disputes to pools of DRS that are organized based on DRS skills, availability, and business relationship with provider (e.g., amount to be paid to DRS, volume of cases committed to handling). Processes are described to allow DRS to better prioritize and view cases in progress. This may be advantageous due to the fact that disputes are also often handled in an asynchronous and iterative fashion online versus a traditional offline mediation that is handled in one or more in-person and continuous meetings. Because of this, a DRS might have multiple open cases all in varying stages of the resolution process, with individual cases potentially taking a duration of multiple weeks to settle however only involving a few minutes of messaging each day. The ODR system addresses this new issue of asynchronicity and high-volume concurrent caseload by providing a means by which a DRS can view status of all cases, so that the DRS can effectively focus on cases in need and advance cases when appropriate. This is partially aided by the system providing tools to sort cases, giving visual clues in case management functionality, as well as providing automated alerts to DRS (e.g., email reminder). For example an alert might be sent when cases have been left unattended by a DRS beyond a defined period of time or an email alert might also be sent to central DRS administration when a particular pool of mediators have reached their capacity and additional disputes being sent to that pool are requiring added attention. The ODR system allows administrators to define pools of mediators with different standards of case management that can be programmed into the system, for example quicker response time requirements for different sets of users. Hence by automatically routing specific user or case types to a specific DRS pool, the system is able to manage a complex new range of dispute resolution and online marketplace service delivery needs.

The ODR system also provides case administration alerts and management tools to assist customer support representatives and the centralize administrators of DRS, and represent unique innovations as to how disputes can be centrally managed and how quality control can be measured all in an online setting. The DRS management tools provided by the ODR system enable management of a global network of DRS and disputes between parties around the world, all from an online interface and using only online modes of communication, online training and support, online case management and online DRS management tools.

The ODR system utilizes the high volume and routine usage of online dispute resolution within an online marketplace to collect very significant data, such as which marketplace users tend to get involved in a dispute, what types of transactions (e.g., item descriptions, item values) are most likely to be disputed, what are the most common types of issues and the most common types of resolutions that users want (or think they want) at the start of a dispute. In addition, the ODR system may collect data through the life cycle of a dispute, such as how quickly users respond, how many times they communicate with one another, and whether they work with one another or through the use of a DRS. As another example, the ODR system may collect data related to the resolution of the dispute, e.g., whether resolution was successful or not, carried out or not, details of the resolution, and the like.

The ODR system may store the collected data in a structured format that can be cross-referenced. This may be especially valuable in drawing linkages that could help improve the underlying functionality of the online marketplace as well as trigger different processes in the underlying marketplace (e.g., non-paying bidder process) or act as an input into various other databases that monitor user risk and fraud potential in the marketplace.

The ODR system may utilize the collected data for enhancing the efficiency of an online marketplace, and improving its processes. The data collected by the ODR system forms a data repository that conventional online marketplaces would not have otherwise, due to the general position taken by a typical online marketplace (e.g., eBay) that it is only a venue and hence not involved in a buyer and seller related dispute, and its lack of willingness to get involved in mediating or determining the appropriateness of claims. The ODR system may analyze this data, or facilitate manual analysis of the data, to aid the online marketplace in determining how to change its own content or other processes to reduce the incidence of disputes, or to alert the marketplace to potential fraud. In this manner, the ODR system may include automated interfaces that alert the online marketplace in certain events, depending on any of the various data inputs, or case lifecycle stages that the online dispute resolution system tracks, in an attempt to greatly enhance the productivity of the marketplace. For example, the ODR system may alert the marketplace if two cases are filed against the same seller within a period of time, e.g., a week, to help alert the marketplace that the seller may have a higher fraud risk associated with them. Similarly, the ODR system may update the marketplace a few days later that this seller has resolved both disputes in a satisfactory fashion, will help reduce the fraud risk associated with the seller.

In one embodiment, the invention provides a method of resolving a dispute in one of a plurality of sectors of an online marketplace involving one or more parties. Information about the dispute is received. A proposed resolution of the dispute is determined based upon at least in part on the one of the plurality of sectors of the online marketplace. The proposed resolution is presented to the one or more parties.

In another embodiment, the invention provides a system for resolving disputes in one of a plurality of sectors of an online marketplace involving one or more parties. A dispute database is configured to store information about the dispute. An application server is operatively coupled to the dispute database for determining a proposed resolution of the dispute based at least in part on the one of the plurality of sectors of the online marketplace in which the dispute arises. A web server is operatively coupled to the application server and adapted to deliver the proposed resolution to a device for presentment to the one or more parties.

The online dispute resolution system can intelligently route a case to an appropriate resolution process based on electronic marketplace rules or precedence informing the online dispute resolution system that a particular case will have higher likelihood of reaching resolution using a specific process. Routing can be between self-settlement processes to help parties directly negotiate a solution or can be transitioned or directly routed to other processes such as mediation, feedback removal review processes, internal insurance claim processes, external claim processes (such as with an third party insurance company). The routing can also be influenced based on factors of the parties in the dispute and pre-commitments the parties have made in association with an electronic marketplace verification program or electronic seal program, such as a “seller guarantee” program. Routing can also be influenced based on specific processes defined by categories, or sectors, of an online marketplace. For example, routing might be different in the general eBay marketplace than for the eBay Motors sector of the eBay marketplace where further, a motors seller might have pre-committed to a “seller guarantee”.

In another embodiment, the invention provides a method of resolving a dispute for a transaction involving one or more parties in one of a plurality of sectors of an online marketplace. Information about the dispute is received. An issue over the transaction involved in the dispute is identified. A proposed resolution of the issue involved in the dispute is identified based at least in part on the one of the routing of sectors of the online marketplace. The proposed resolution is presented to the one or more parties.

In another embodiment, the invention provides a system for resolving a dispute for the transaction involving one or more parties in one of a plurality of sectors of an online marketplace. A dispute database is configured to store information about the dispute involving the transaction. An application server is operatively coupled to the dispute data store and adapted to identify an issue involved in the dispute over the transaction and to identify a proposed resolution of the issue based at least in part on the one of the plurality of sectors of the online marketplace. A web server is operatively coupled to the application server and is capable of delivering a proposed resolution to a device for presentment to the one or more parties.

In another embodiment, the invention provides a method of resolving a dispute in an online marketplace involving one or more parties. Information about the dispute is received. A proposed resolution of the dispute is determined based at least in part on a point of entry into the method of resolving the dispute from the online marketplace.

Dynamically generated messaging within the online dispute resolution process can also be modified based on the party involved. Altered messaging based on a user or party can increase participation in online dispute processes. For example the dispute resolution system might recognize a participant who is a repeat or high volume user of ODR, or a member of a related seal program with associated standards of behavior. In such a case the system might modify language customized to that participant or other tailoring to influence participation and effective resolution.

In another embodiment, the invention provides a system for resolving a dispute in an online marketplace involving one or more parties. A dispute database is configured to store information about the dispute. An application server is operatively coupled to the dispute database for determining a proposed resolution of the dispute based at least in part on a point of entry into the method of resolving the dispute from the online marketplace. A web server is operatively coupled to the application server and is capable of delivering the proposed resolution to a device for presentment to the one or more parties.

In another embodiment, the invention provides a method of resolving a dispute in one of a plurality of sectors of an online marketplace involving one or more parties. Information about the dispute is received. Information about at least one of the one or more parties is received. Attributes of the at least one of the one or more parties are verified relative to the online marketplace. A resolution of the dispute is determined based at least in part on the verification.

In another embodiment, the invention provides a system for resolving a dispute in one of a plurality of sectors of an online marketplace involving one or more parties. A dispute database is configured to store information about the dispute. An application server is operatively coupled to the dispute data store and is adapted to receive information about at least one of the one or more parties, verify attributes of the at least one of the one or more parties relative to the online marketplace and determine a resolution of the dispute based at least in part on the verification.

In another embodiment, the invention provides a method of resolving a dispute in one of a plurality of sectors of an online marketplace involving one or more parties. Attributes of the one or more parties who initiate the method are identified. An issue involved in the dispute is identified. Possible resolutions of the issue are identified. Attributes of one of the one or more parties who respond to the method are identified. The issue is clarified. Possible procedures to resolving the dispute are identified.

In another embodiment, the invention provides a method of resolving a dispute in one of a plurality of sectors of an online marketplace involving one or more parties. Information about dispute is received. A proposed resolution of the dispute is determined. A reputation rating of at least one of the one or more parties is updated as a function of the resolution.

In another application of reputation or feedback related online dispute resolution, the online dispute resolution system can process feedback related to disputes where the other party does not respond. The online dispute resolution process can be designed to give fair warning to the other party who left a negative feedback about the filing party. If the other party does not respond within the rules set by the online marketplace, the online dispute resolution system can determine if the transaction and feedback left meet appropriate standards for removal as set by the marketplace. If within standards the online dispute resolution system can, either automatically or through a dispute resolution specialist, approve feedback removal. An automated request can be generated to the online marketplace from the online dispute resolution system to authorize correcting the feedback. If however the party does respond, the dispute can be routed to other appropriate processes, that are either automated or specialist assisted.

In another embodiment, the online dispute resolution system can process feedback related to disputes where both parties have agreed to the feedback removal and there is no further underlying issue to be resolved. The online dispute resolution system can determine if the transaction and feedback left meet appropriate standards for removal as set by the marketplace. If within standards the online dispute resolution system can, either automatically or through a dispute resolution specialist, approve feedback removal. An automated request can be generated to the online marketplace from the online dispute resolution system to authorize correcting the feedback. If however the party does respond, the dispute can be routed to other appropriate processes, that are either automated or specialist assisted.

In another embodiment, the invention provides a system of resolving a dispute in one of a plurality of sectors of the online marketplace involving one or more parties. A dispute database is configured to store information about the dispute. An application server is operatively coupled to the dispute database and adapted to determine a proposed resolution of the dispute and update a reputation rating of at least one of the one or more parties as a function of the resolution.

In another embodiment, the invention provides a method of administering a reputation rating of a first user of an online marketplace in which a second user provides feedback relative to the reputation rating of the first user. Reputation information based on feedback from the second user about the first user is received. The first user is automatically notified of negative feedback from the second user.

The system can be further customized by the user of the service to define under what circumstances notifications are sent. Parameters can include such variables as age of transaction, size of transaction, reputation specific factors such as ratio of positive to negative feedback.

In another embodiment, the invention provides a system for administering a reputation rating of a first user of an online marketplace in which a second user provides feedback relative to the reputation rating of the first user. A database is configured to hold information concerning the feedback. A communication module is operatively coupled to the database and adapted to automatically notify the first user of negative feedback.

In another embodiment, the invention provides a method of administering a reputation rating of a first user of an online marketplace in which a second user provides feedback relative to the reputation rating of the first user. An electronic dispute resolution process is entered between the first user and the second user regarding the reputation rating of the first user. The reputation rating of the first user can be updated based upon the outcome of the electronic dispute resolution process.

In another embodiment, the invention provides a system for administering a reputation rating of a first user of an online marketplace in which a second user provides feedback relative to the reputation rating of the first user. A database is configured to hold the reputation rating. An application server is operatively coupled to the database and adapted to resolve a dispute between the first user and the second user over the reputation rating resulting in a resolution and updating the reputation rating based upon the resolution.

In another embodiment, the invention provides a method of administering a reputation rating of a first user of an online marketplace in which a second user has provided feedback relative to the reputation rating of the first user. A request from the first user challenging the feedback provided by the second user is received. The second user is notified of the request. The reputation rating of the first user is updated if the second user does not respond to the notification.

In another embodiment, the invention provides a method of resolving a dispute in an online marketplace involving one or more parties. A commitment for payment for the electronic dispute resolution process is received from one or more parties involved in the dispute. Information about the dispute is received from the one or more parties who committed to payment and payment is received. A proposed resolution of the dispute is determined. The proposed resolution is presented to the one or more parties.

In another embodiment, the invention provides a method of resolving a dispute in an online marketplace involving one or more parties. Information about the dispute is received. A time for payment for an electronic dispute resolution process is determined as a function of an attribute of the dispute. Payment for the electronic dispute resolution process is received. A proposed resolution of the dispute is determined. The proposed resolution is presented to the one or more parties.

In another embodiment, the invention provides a method of administering an online dispute resolution process involving a plurality of disputes, each of the plurality of disputes involving one or more parties. The plurality of disputes are automatically prioritized for handling by a dispute resolution specialist. The plurality of disputes are displayed to the dispute resolution specialist.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is a block diagram of an example online dispute resolution system in accordance with the principles of the invention;

FIG. 1B is a block diagram that illustrates the example online dispute resolution system of FIG. 1 in further detail;

FIG. 2 is a block diagram that illustrates an exemplary tool set for dispute resolution specialist (DRS) and other case administrators provided by the online dispute resolution system of FIG. 1A;

FIG. 3 is a flow chart illustrating an overview of online dispute resolution process in accordance with the invention;

FIG. 4 is a flow chart a block diagram illustrating linkages to an online dispute resolution in accordance with the invention;

FIG. 5 is a flow chart flow chart illustrating a filing process in an online dispute resolution system in accordance with the invention along with new process to request negative feedback removal when there is no response by the other party

FIG. 6 is a flow chart flow chart illustrating a response process in an online dispute resolution system in accordance with the invention;

FIG. 7 is a flow chart illustrating a reputation correction process in accordance with the invention;

FIG. 8 is a flow chart illustrating a negative reputation notification process in accordance with the invention;

FIGS. 9 through 70 are screenshots or procedural flow diagrams of an implementation of the invention on an online marketplace.

### DETAILED DESCRIPTION

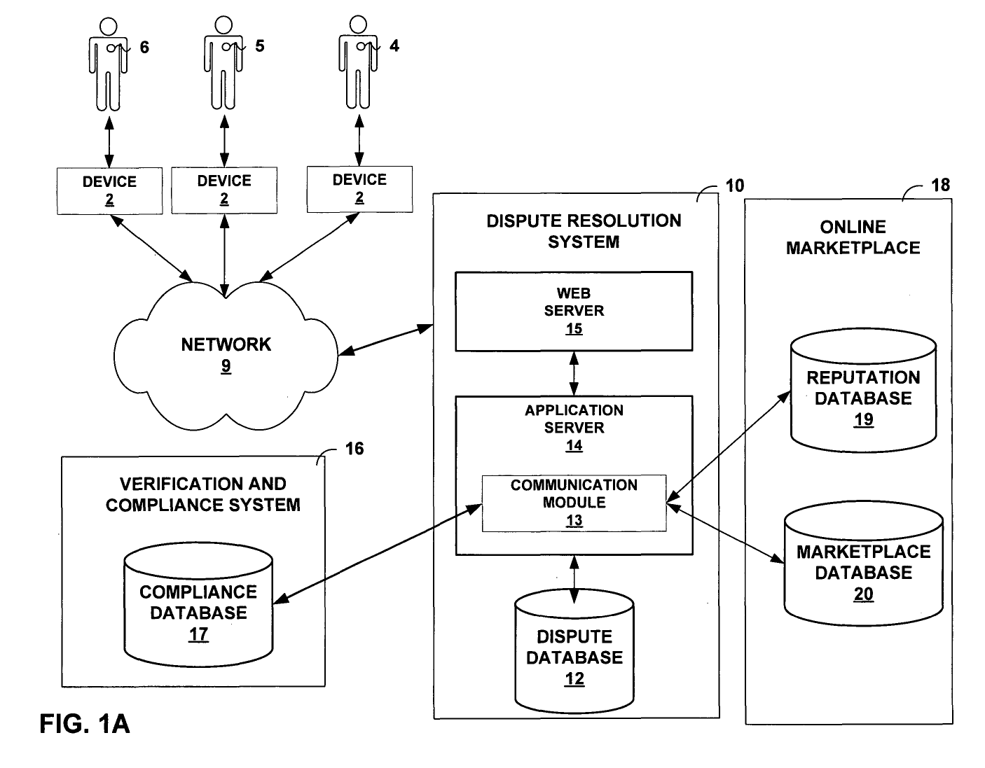

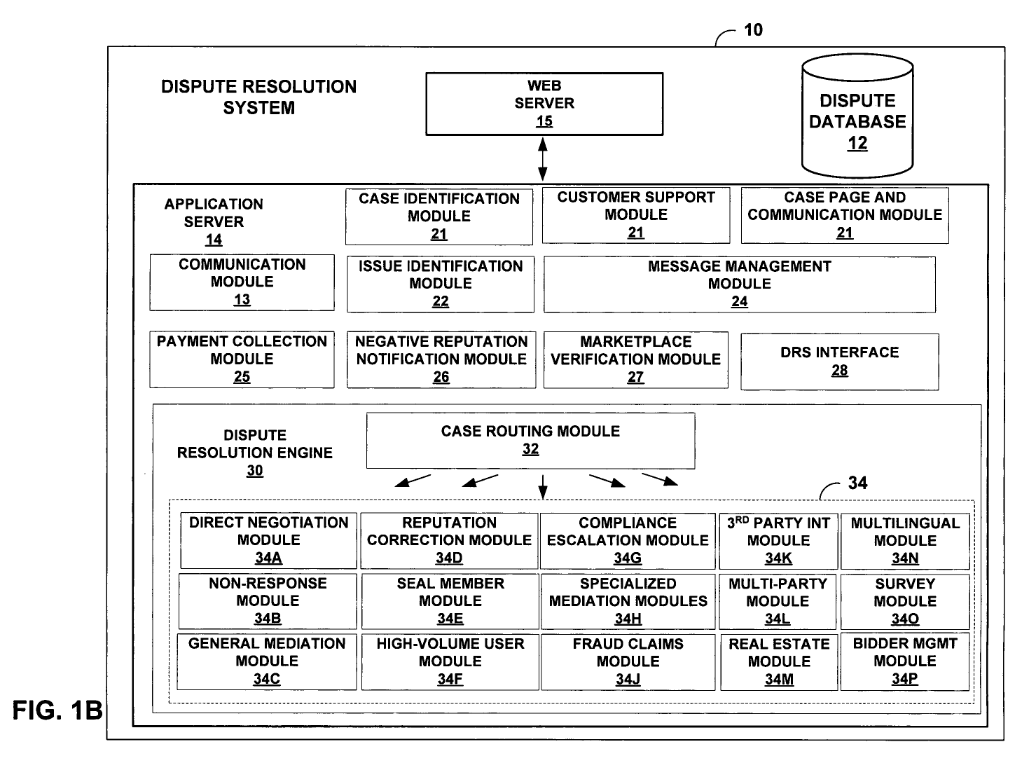

FIG. 1 illustrates a high-level block diagram of an online dispute resolution (ODR) system 10 for resolving disputes in electronic commerce, such as through a web site or in an online marketplace. A dispute database 12 is configured to store information about a dispute, usually involving a transaction in electronic commerce, between one or more parties 4, e.g., a “filer” and a “respondent.”

Application server 14 is operatively coupled to dispute database 12 and is configured to perform many dispute resolution tasks in ODR system 10. Application server 14 is operatively coupled to web server 15 which is adapted to communicate through a network 9, such as the Internet, and through one or more devices 2, such as a personal computer, to one or more parties 4. In particular, web server 15 provides an interface for communicating with parties 4 via devices 2. In addition, web server 15 provides an interface for communication with a set of dispute resolution specialists (“DRSs”) 5 that may aid the online resolution of disputes submitted by parties 4 In addition, web server 15 provides an interface for communication with a set of dispute resolution administrators 6, that may be customer service representatives, DRS administrators or other product administrators supporting the ODR system., that may aid the online resolution of disputes submitted by parties 4 or overall ODR system 10 management.

Web server 15 provides an operating environment for interacting with device 2 according to software modules 2A, which can include Active Server Pages, web pages written in hypertext markup language (HTML) or dynamic HTML, Active X modules, Lotus scripts, Java scripts, Java Applets, Distributed Component Object Modules (DCOM) and the like. Although illustrated as “server side” software modules executing within an operating environment provided by web server 15, software modules 2A could readily be implemented as “client-side” software modules executing on computing devices 2 used by parties 4, 5 and 6. Software modules 2A could be, for example, implemented as Active X modules executed by a web browser executing on the computing devices.

Communication module 13 executing on application server 14 provides an interface, e.g., an application programming interface (API) for communicating with a reputation database 19 in order to support corrections to reputation database 19 of marketplace 18. Similarly, communication modules provide an interface for communication with online marketplace transaction database 20 in order to provide automated validation of data and other marketplace integration with the online dispute resolution system.

In addition, communication module 13 may link ODR system 10 and verification and compliance system 16, which is a system for administering “seals of verification” in an electronic marketplace. The term “seal of verification” generally corresponds to imagery or other media that is often used to indicate that an entity's credentials, policies, or pre-commitments to business practices have been verified by an issuer of the seal, i.e., verification and compliance system 16. The seal is typically presented to a user as a portion of a website, e.g., via a website presented by online marketplace 18.

One example of such a system is the system described in U.S. patent application Ser. No. 09/634,149, filed Aug. 8, 2000, entitled “Electronic Seals,”, the contents of which are hereby incorporated by reference. Another example is the system described in U.S. Provisional Patent Application Serial No. 60/470,345, filed May 14, 2003, entitled “SYSTEM AND METHOD FOR MANAGING A SEAL OF CERTIFICATION,” the contents of which are hereby incorporated by reference.

Communication module 13 may provide access to a member compliance database 17, which maintains user profiles as part of the online seal or online verification and compliance system 16. Compliance database 17 may be periodically synchronized, e.g., daily, with marketplace database 20 and reputation database 19 of marketplace 18 and dispute database 12 of online dispute resolution system 10. Communication module 13 can access compliance database 17 and inform ODR system 10 if a particular user has specific pre-commitments to mediate or other relevant selling standards. As another example, direct access may be provided, e.g., by use of hyperlinks to ODR system 10 from various locations, e.g., web pages, in and around verification and compliance system 16 is one example of a direct link between the systems. As another example, compliance and verification system 16 may access ODR system 10 for purposes of evaluating whether a party or an online entity meets the requirements for a seal of certification based, at least in part, on of such party's or online entity's history in ODR system 10. In particular, verification and compliance system 16 may access dispute database 12 when determining whether to issue a seal of certification to an online entity, e.g., one of parties 4. Of course, these are a few examples. Many other examples may be possible.

FIG. 1B is a block diagram that illustrates the example ODR system 10 of FIG. 1A in further detail. In the illustrated embodiment, ODR system 10 includes a number of software modules including communication module 13, Case identification module 21, issue identification module 22, message management module 24, payment collection module 25, negative feedback notification module 26, marketplace verification module 27, dispute resolution specialist (“DRS”) interface 28, dispute resolution engine 30, and case routing module 32. Although illustrated for exemplary purposes as separate software modules executing on an operating environment provided by application server 14, the functionality of the software modules may be implemented in one or more software modules.

As described in further detail below, ODR system 10 receives case filing information from a “filer,” and possibly response information from a “respondent,” i.e., parties 4. Case identification module 21 allows the ODR system to collect key information to most appropriately route the case and customize the user experience for the parties in the dispute 4. This can include recognizing referring URL, or on information collected from filer to indicate such things as: the online marketplace 18 where dispute occurred, country of dispute, language requirements, category of marketplace, payment type, and filer profiles. The case identification module 21 can trigger specific processes in other modules based on key attributes of the filer or respondent, based on pre-commitments (e.g., if either is a seal member), level of activity (e.g., if parties are “power sellers” or high volume users of an online marketplace). Issue identification module 22 identifies relevant issues within disputes filed by the parties 4 in order to aid the routing and processing of the cases. Issue identification module 22 may assist the parties 4 or the DRS 5 by accessing dispute database 12 and mapping case information to data for similar cases that have already been handled in a marketplace, sub-marketplace, or based upon the filer or respondent (e.g., tailored to who is filing the case). For example, issue identification module 22 may provide multiple issue types as relevant to the point of entry to the dispute resolution system, for example in an online marketplace where the filer is a buyer, this might include: “payment sent but merchandise not received”, “damaged merchandise”, “incomplete merchandise”, “received merchandise late”, “merchandise different from described”, “negative feedback threatened”, “I would like negative feedback removed”, “non-paying bidder”, “bid shilling.” Case page and communication module 23 provides the secure platform to view case information and view historic and current communications with the other party 4, the DRS 5 or other case administrators 6.

Message management module 24 generates messages and handles communication with parties 4, DRS 5, and other ODR system administrators 6 during the dispute resolution process. Messaging can include standard confirmations, requests for participation, automated alerts to respondent to participate, notices of case closure, and alerts to DRS if cases have been left unattended. Payment collection module 25 collect payments or payment information from parties 4 as necessary. Negative reputation notification (NRN) module 26 periodically accesses or otherwise monitors member compliance database 17 to identify any recently posted negative reputation ratings within an online reputation system, for example a feedback system in an online marketplace. Once identified, the NRN module 26 issues a message to the negatively impact party 4 to allow the party to easily and quickly take action based on the newly received negative reputation through the ODR system 10.

Marketplace verification module 27 may access an online marketplace database 20 of an online marketplace 18, where the disputed transaction may have occurred, to verify certain transaction or user information or pre-fill information about the transaction, filer or respondent 4.

DRS interface 28, as further illustrated in reference to FIG. 1B, provides a comprehensive interface by which multiple administrators can interact with ODR system 10 to assist in online dispute resolution or manage the overall system. These parties can include a dispute resolution specialist (“DRS”) 5 or other dispute resolution administrators 6, which may be customer service representatives, DRS administrators or other product administrators supporting the ODR system. Customer support module 29 provides an integrated tools and communication capabilities for users 4 to find answers to frequently asked questions or specific questions related to a dispute with customer support staff or other DRS administrators 6.

Communication module 13 allows modules and the overall system to communicate with other related systems to facilitate ODR processes or to support the other related systems, for example, online marketplace systems 18 such as reputation systems 19 and online market place database 20 interaction, verification and compliance systems 16, fraud detections systems associated with an external marketplace 18 or an integrated verification and compliance system 16.

Dispute resolution engine 30 includes, among others, case routing module 32 and a plurality of dispute resolution modules, including 34A-34N. Case routing module 32 routes cases to appropriate dispute resolution modules 34 of dispute resolution engine 30 based on the identified issues for each case. In the exemplary embodiment, dispute resolution modules 34 can include a direct negotiation module 34A, a non-response module 34B, a general mediation module 34C, a reputation correction module 34D, a seal member module 34E, a high-volume user module 34F, a compliance escalation module 34G, specialized mediation modules 34H, decision based module 34I, a fraud claims module 34J, 3^{rd} party interaction (e.g., 3^{rd} party insurance) module 34K, a multi-party module 34L, a real estate module 34M, an multilingual module 34N, a survey module 340, a non-paying bidder management module 34P.

Direct negotiation module 34A allows parties 4 to directly negotiate via case page and communication module 23 and message management module 24 to resolve disputes. Non-response module 34B allows a party 4 to either report a complaint or proceed to one or more other relevant module(s) if the other party does not respond (e.g., reputation correction module 34D, compliance escalation module 34G, fraud claim module 34J), via the case page and communication module 23 and message management module 24 to process disputes. General mediation module 34C allows parties 4 to work with a professional mediator or DRS 5, via case page and communication module 23 and message management module 24 to resolve disputes. Reputation correction module 34D allows parties 4 to work with a professional mediator, DRS 5, via case page and communication module 23 and message management module 24 to resolve disputes, or may include an automated negotiation process to agree to reputation or feedback retraction or correction. Reputation correction module 34D applies processes to ensure that reputation database 22, marketplace database 30 and compliance database 38 are updated to, for example, remove negative feedback in the event a dispute is resolved. Seal member module 34E and high-volume user module 34F can provide a specialized process when a seal member or high volume user is either the filer or respondent in a dispute. This can include both direct negotiation and DRS facilitated processes, where the system can provide customized messaging via the communication module 23 and message management module 24 to resolve disputes to acknowledge pre-commitments of the seal member, familiarity of the user, as well as potentially special attention from DRS 4. Compliance escalation module 34G, is a parallel process to all modules, where all stages of case filing and response iteration update the compliance database 17 of verification and compliance systems 16. Specialized mediation modules 34H are used for specialized mediation or other DRS processes customized for various applications, for example a specialized DRS process within the motors category or a marketplace. Decision based module 34I allow processes to included recommended resolutions or rules based decisions, for example a marketplace rule base for feedback removal, or marketplace participation. Decision based module 34I may stand along or may follow an unresolved other dispute resolution module and utilize communication module 23 and message management module 24 to resolve disputes.

Fraud claims module 34J can be specific to marketplace 18 and/or verification and compliance system 16, and handles cases in which one or more parties 4 alleges fraud or where the related systems suspect fraud may be involved. 3^{rd} party interaction (e.g., 3^{rd} party insurance) modules 34K, handle cases that involve interaction with a 3^{rd} party process, e.g., insurance claim in motors category, payment dispute process for payment provider. Multi-party module 34L enables more than one party to be a filer or respondent in other modules. Real estate module 34M, handles cases specifically related to real estate purchases. Multilingual module 34N, handles cases where filer and respondent speak different languages. Survey module 340, processes post dispute feedback from users 4 of the ODR system 10 to rate the system, DRS 5 and other attributes to maintain quality control and continuous improvement. Non-paying bidder module 34P, processes cases where a party complains about non-paying bidders and would like a specialized contact process to buyers and to help them have their money returned by the marketplace.

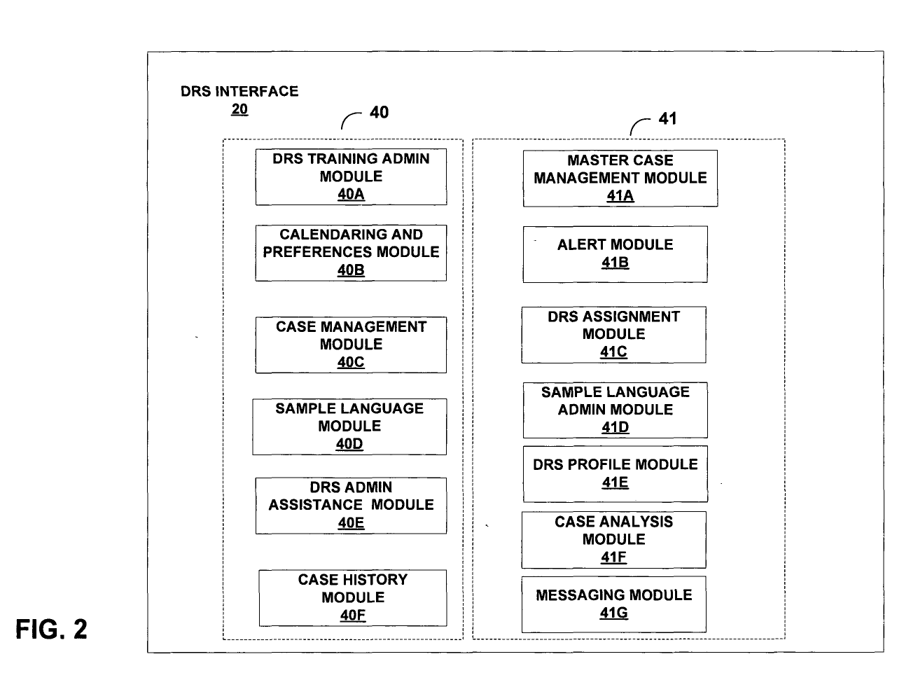

FIG. 2 is a block diagram that illustrates an exemplary dispute resolution specialist (DRS) interface 28 provided by ODR system 10 of FIG. 1B. More specifically, DRS interface 28 provides a comprehensive suite of software modules 40, 41 for training and supporting a distributed or local network of Dispute Resolution Specialists (DRS) 5, as well as supporting general ODR system administrators and customer support staff 6 to conduct online dispute resolution.

Individual DRS or DRS trainees 5 can access modules 40 of DRS interface 28 using device 2, such as a personal computer, that has access to communication network 9. DRS interface 28 may provide is a password protected area within a web interface presented by web server 18 where DRS 5 can access all tools required to be trained, conduct online dispute resolution and other administrative functions. For example, online training module 40 provides a forum for training DRS 5, and can be conducted online or offline. The online training module 40 can also provide ongoing education as to best practices as updated by central DRS Administration.

Once trained and approved to conduct cases, DRS 5 can utilize the calendaring and case preference module 40A to request desired case load, show availability, and other administrative features, such that a central DRS administrator or ODR system 10 in automated fashion can assign cases accordingly.

DRS interface 28 also provides a case management module 40C that assists DRS 5 in administering individual cases, as well as prioritizing their activities to the full case load. The functionality includes visual alerts as well as automated alert module 40C that might send emails to the DRS for various reasons (such as a case that has been left unattended) or it may highlight cases.

Case management module 40C can also highlight special attributes of cases to DRS 5 to help the DRS more easily provide more tailored communications or processes with specific users or case types. For example, case management module 40C might highlight users who are high-volume sellers or buyers in marketplace 18, or users who have made certain pre-commitments to verification and compliance system 16, e.g., “Seal” members. Based on this information, master case management module 40C may instruct DRS 5 to handle cases with different standards or processes (e.g., quicker response times, tailored language based on pre-commitments of the parties). DRS 5 can also access other modules to assist them in individual case administration, such as sample language module 40D that aids the DRS in finding appropriate language for similar case types.

DRS administration assistance module 40E allows a DRS to request and receive assistance from central DRS administrators. In particular, DRS administration assistance module 40E allows the central DRS administrators to view live cases for those DRS 5 requesting assistance. Case history module 40F allows each DRS 5 to view historical cases which they have conducted.

DRS administrators, customer support staff and other ODR administrators 6 also can access a set of case administration modules 41. In particular, master DRS management module 41A can provides varying levels of access to all modules of DRS interface 28, and allows the administrators to administer and improve ODR system 10. Accordingly, DRS administrators can administer training of individual trainees or general modules that can be alerted to all DRS for continuing education. Through the master case management module 41A, administrators can have a master view of all DRS 5 or can view by cases, both open and historic. This allows administrators to provide quality control and individual attention to cases that might need help. Alert module 41B helps highlight administrators to DRS pools, individual DRS or individual cases either via messages, such as email or by highlighting on the interface. DRS administrators can view current or historic cases and collaborate with DRS 5 that require assistance or perform quality control on specific DRS.

DRS assignment module 41C allows DRS administrators to assign specific cases to DRS or to general pools, e.g., groups, of DRS. The module allows setting the pools, rules for the pools, and alert parameters (such as when a pool might be nearing capacity). Sample language administration module 41D allows central administrators to collate suggestions from DRS 5 based on best practices. DRS profile module 41E allows administrators to manage individual DRS, assemble feedback they receive from users, keep notes as to their training or other experience. Case analysis module 41F allows administrators to view disputes and resolutions in different ways, extract data at aggregate or case level, to help analyze effectiveness of system or other patterns to help improve the system or improve the system interacting with other systems, e.g., online marketplace 18 or verification and compliance systems 16. Messaging module 41G, allows customers support staff or other case administrators to coordinate messages with disputing parties 4 or other administrators 5, 6 in relation to a case or user so that all related communications can be readily available. One or more of the modules 41 may issuing alerts to inform the dispute resolution specialist administrator when one or more of the pools approach a defined capacity of assigned dispute, or to inform the dispute resolution specialist administrator when a response time of one or more of the dispute to their respective assigned disputes drops below a defined response period.

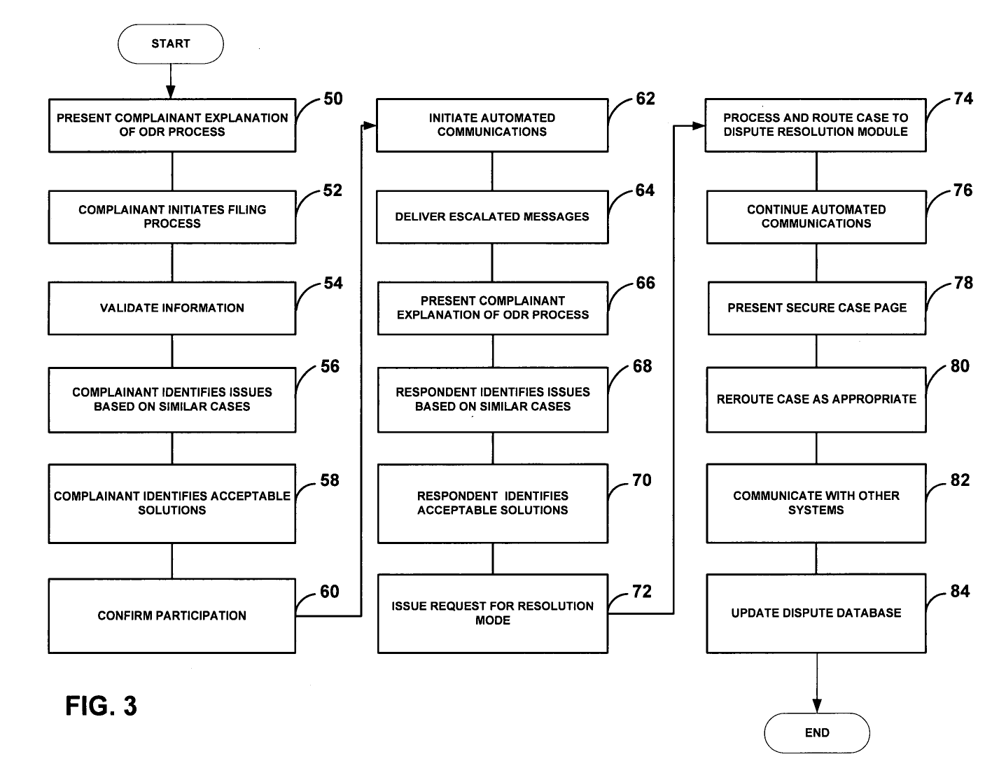

FIG. 3 is a flowchart illustrating an overview of operation of exemplary ODR system 10 in accordance with the invention. In general, ODR system 10 presents a party 4, e.g., a complainant, the content and explanation of the dispute resolution process from various points of entry in a manner that is focused on encouraging participation in the online dispute resolution process (50).

The complainant initiates the filing process (52) by identifying key factors associated with the disputed transaction. Such factors can include the filer's identity and role in the transaction (e.g., buyer, seller), the marketplace 18, a sub-marketplace of the marketplace 18 (e.g., motors, travel, electronics), or other place where dispute occurred (e.g., a real estate transaction), type of transaction, mode of payment used (e.g., online payment like PayPal™, credit card, check), and information about the filer and the other party in the dispute, contact information for the filer and the country or language used.

System 10 might validate (54) certain transaction or user information with marketplace database 20 of online marketplace 18 where the disputed transaction occurred. System 10 may also only automatically extract certain details of the transaction during the validation phase. The complainant (filer) identifies (56) the issue type(s) from a relevant list of selections that can be generated by mapping their initially identified information to similar cases that can be based on precedence of similar cases in a given marketplace or similar setting. The complainant identifies (58) acceptable resolutions from a list of selections presented next to each issue type. The list of selections presented is intelligently based on past information provided by filer and tailored to the issue type and can also be tied to common outcomes based on precedence in that marketplace or setting.

Further, the complainant might be requested to confirm (60) that they will participate in a certain mode of resolution (for example, feedback removal mediation) or the complainant may be given the option to choose a mode of resolution, for example, direct negotiation mediation, etc. ODR system 10 can recommend a mode of resolution based on issue type and resolution type, e.g., a feedback dispute. Where ODR system 10 recognizes that a fee based dispute resolution process is or might be required, the system can automatically request payment information from the party and obtain pre-authorization to charge the party for the dispute resolution service. In certain situations communication module 13 of ODR system 10 may update directly online marketplace database 20 or reputation database 19 of marketplace 18 directly to based on issue and party information collected so as to trigger related and unrelated marketplace processes (e.g., updates to online marketplace fraud alert system or online marketplace non-paying bidder process).

Next, ODR system 10 communicates with both parties (62). The communication can be automated and electronic in nature, and the content may be dependent upon the dispute type and issue involved as well as the time elapsed of non-response. The filer can be continuously updated if the other party does or does not respond. Communications to the other party are tailored to encourage participation. Communication to the other party also can deliver escalating messages related to the consequence of non-response if a feedback/reputation dispute is involved or other kind of dispute where non-participation has certain ramifications on user conduct in the on-line marketplace—e.g., non-paying bidder (64). ODR system 10 presents the respondent content and explanation of the dispute resolution process from various points of entry to online dispute resolution to encourage their participation (66).

The respondent begins the response by viewing the key facts of the disputed transaction and identifies the issues involved in the dispute (68). The respondent identifies possible resolutions from a list of selections presented (70). ODR system 10 intelligently bases the list of selections on the complainant's issues and responses. The selections are displayed so as to encourage quick settlement with highlighting graphic techniques to help parties see where they are in agreement or disagreement. ODR system 10 may issue a communication requesting the respondent to participate in a particular mode of resolution (72), for example, mediation, which might have also already have been pre-agreed by the other party. The other party might also request to direct the dispute to a specific process and could be prompted for payment information and authorization to charge if the process is fee-based.

In certain situations, ODR system 10 may automatically route a case from block 56, 58 or 60 (i.e., after identifying the issue type) directly to block 74 where it is determined that a case should be handled by an alternative internal or external process and can be directed to that process based on issue and party information collected (e.g., transferred to an online payment or online marketplace fraud claim process or online marketplace non-paying bidder process). In certain other cases, a case might be automatically routed from block 64 to block 74 where it is determined that certain actions (e.g., removal of a reputation comment) can occur even if the respondent does not respond.

Case routing module 32 of ODR system 10 processes (74) the case, and routes the case to one of dispute resolution modules 34 according to many factors, including the parties' responses and preferences and can be dependent upon the dispute type and, possibly, dependent upon the sector of the marketplace which involves the dispute or in within which the dispute arises. The dispute can be assigned to broad permutations of processes, that can be preprogrammed to escalate from one process to the next, including: direct negotiation, general mediation, specialized mediation (for example, an automotive seller guarantee), feedback removal processes, international mediation (for example, due to language preferences), a specialized process (for example, no response in a feedback dispute), and assigned to compliance (for example, if the dispute or transaction is contrary to policy).

ODR system 10 communicates (76) with both parties, the content of which may be tailored by dispute type. Automated reminder messages, which can be electronic, encourage participation by both parties. Case page and communication module 23 constructs a secure case page (78) that both parties may access electronically via web server 15. The secure case page is configured so that the case can move forward in an asynchronous manner such that no party has to be logged on at the same time. Other modes of synchronous communication can also be facilitated here.

During resolution, the dispute may be moved, i.e., re-routed, (80) to the appropriate dispute resolution modules 34 as necessary. For example a dispute may be re-routed from direct negotiation to general mediation, if appropriate. If not already collected, ODR system 10 will request payment information from the party and pre-authorization to charge for the dispute resolution service if required. Mediation may be performed. This might include routing case to a specific dispute resolution specialist (DRS) 5 or pool of DRS to handle specific dispute types, customer types, marketplaces types, etc. In an appropriate circumstance, e.g., automotive, a third-party, e.g., insurance companies, maybe involved.

Based on the participation and outcome of the ODR process, communication module may interact with marketplace 18 and/or verification and compliance system 16 to update or otherwise inform the systems (82). Other examples of external systems with which ODR system 10 may interact include an online marketplace reputation system, an online marketplace non-paying bidder system, and an online marketplace fraud alert system. ODR system 10 may also update dispute database 12 storing historical cases (84) that can be used to further improve ODR system 10.

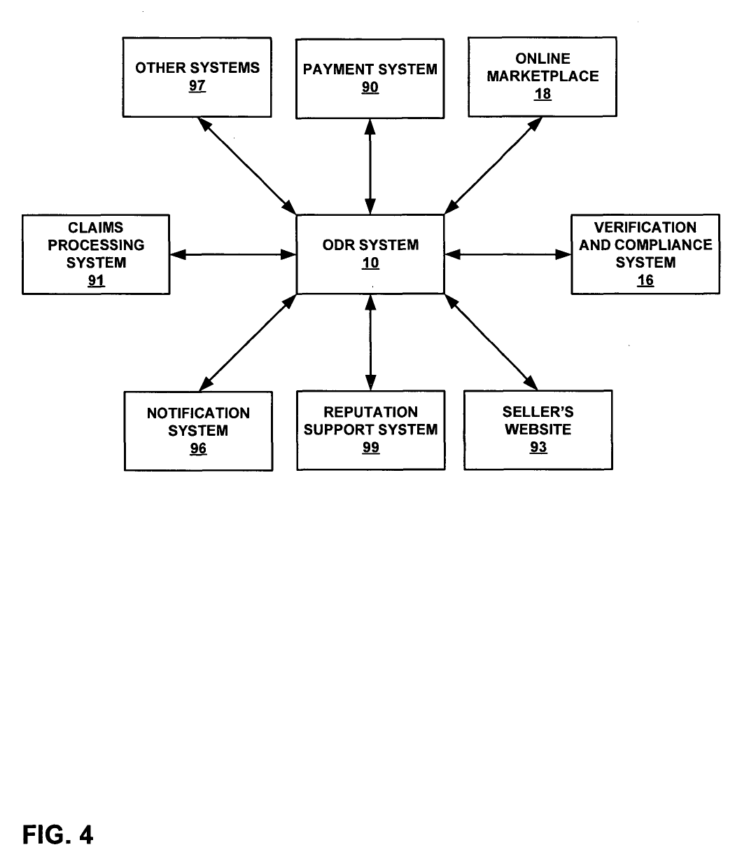

FIG. 4 is a block diagram illustrating exemplary linkages to ODR system 10 from electronic commerce systems, including online marketplace 18 and verification and compliance system 16 described above in reference to FIG. 1. Online dispute resolution system 10 may be accessed from a payment system 90, for example, traditional off-line credit and debit card payments and from online person to person payment systems such as PayPal™ or C2it™ to provide dispute resolution functionality for resolving disputes associated with payment system 90. As another example, ODR system 10 may interact with a claims processing system 91, for example, that processes marketplace fraud claims or 3^{rd} party insurance programs or marketplace seller-oriented non-paying bidder programs. ODR system 10 may also be accessed from an individual seller's web site 93 or electronic seal or other online verification and certification system 16, particularly when such systems require pre-commitment to a form of dispute resolution which would otherwise be impractical unless an online dispute resolution process exists.

ODR system 10 may also be accessed from a reputation support system 99 or from a proactive notification system 96 to alert a customer to a dispute resolution need, for example, a negative reputation response notification. ODR system 10 may also be accessed from other systems 97 with a need for online dispute resolution services.

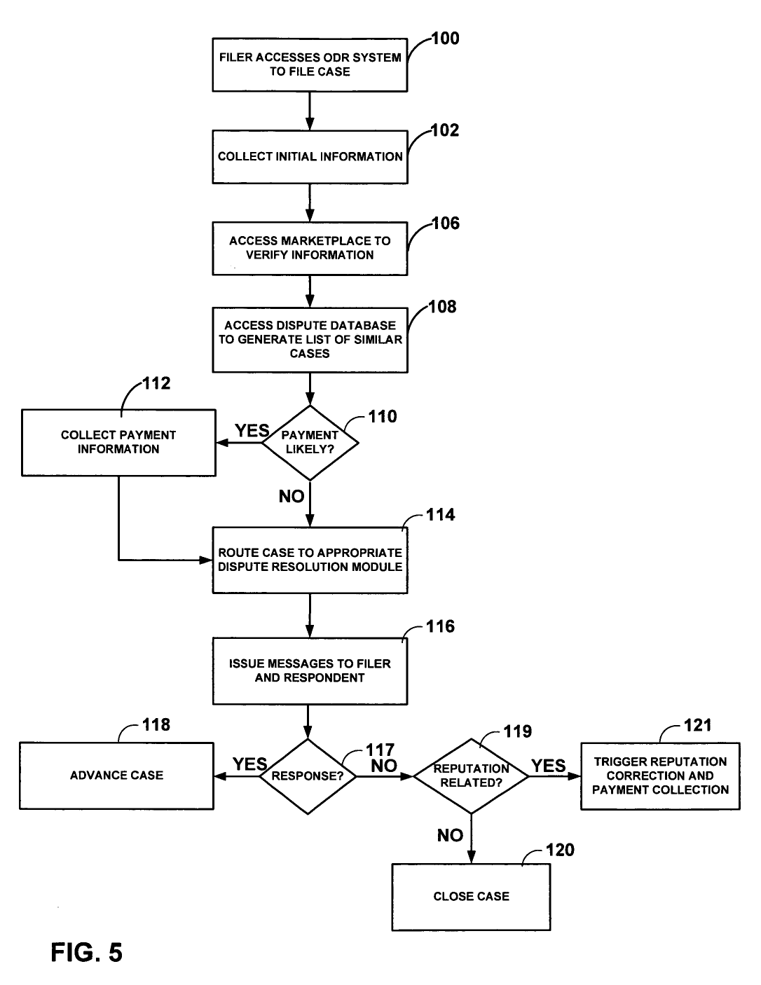

FIG. 5 is a flow chart illustrating the dispute filing process, which includes non-response reputation cases. Initially, a filer accesses the ODR system 10 to file a dispute (100). ODR system 10 collects information about the filer and the disputed transaction (102). Such factors collected by ODR system 10 can include the filer's role in the transaction (e.g., buyer, seller), the marketplace 18, a sector of the marketplace (e.g., motors, travel), or other place where dispute occurred (e.g., a real estate transaction), type of transaction, mode of payment used (e.g., online payment like PayPal™, check), and information about the filer and the other party in the dispute, contact information for the filer and the country or language used. Marketplace verification module 27 may access marketplace database 19 of online marketplace 18 where the disputed transaction occurred to verify certain transaction or user information or pre-fill information about the transaction, filer or respondent (106).

Once verified, issue identification module 22 identifies relevant issues within the filed dispute from a relevant list of selections that can be generated from dispute database 12 by mapping the initially identified information to similar cases that can be based on precedence of similar cases in a given marketplace or similar setting (108). This process may be performed in an automated, semi-automated, or manual form.

If case routing module 32 determines that payment is required or likely (110), the case routing module routes first routes the case to payment collection module 25 to collect payment or to get payment information and pre-authorization to take payment (112). Next, based on the identified issues, case routing module 32 routes the case (114). Any of dispute resolution modules 34 may receive the case, for example, fraud claims handling or an online payment process that might be administered by an online marketplace or other third party.

The information collection, issue identification and a resolution identification processes can be automatically tailored based on the identity of the parties, the type of transaction, the sector of the marketplace, the value of the transaction, etc. The tailoring also includes automatically generating proposed issue clarifications and resolution suggestions based on precedence of similar cases, facilitating recognition of reasonable alternatives and compromise, without the assistance of a human mediator or equivalent.

Message management module 24 issues a message to the filer indicating that the case has been filed, and issues a communication requesting the respondent's participation (116). If the dispute is feedback or reputation-related, message management module 24 may include multiple attempts to notify the respondent based on marketplace rules for non-responsive feedback removal. If the respondent responds (117), ODR system 10 advances the case advances to the dispute resolution process (118). If there is no response from the respondent and the case is not feedback related (119), message management module 24 notifies the filer of non-response and the case is closed (120). If however, the case is feedback related, reputation correction module 34B is triggered, as well as payment collection module X is activated, if appropriate (121). In a similar vein, if respondent's responding impacts another of the modules (e.g., non-paying bidder-340), then the message management module 24 may cause the non-paying bidder module 340 to be triggered. Throughout processes, dispute resolution database 12 is continuously updated with each event associated with a case.

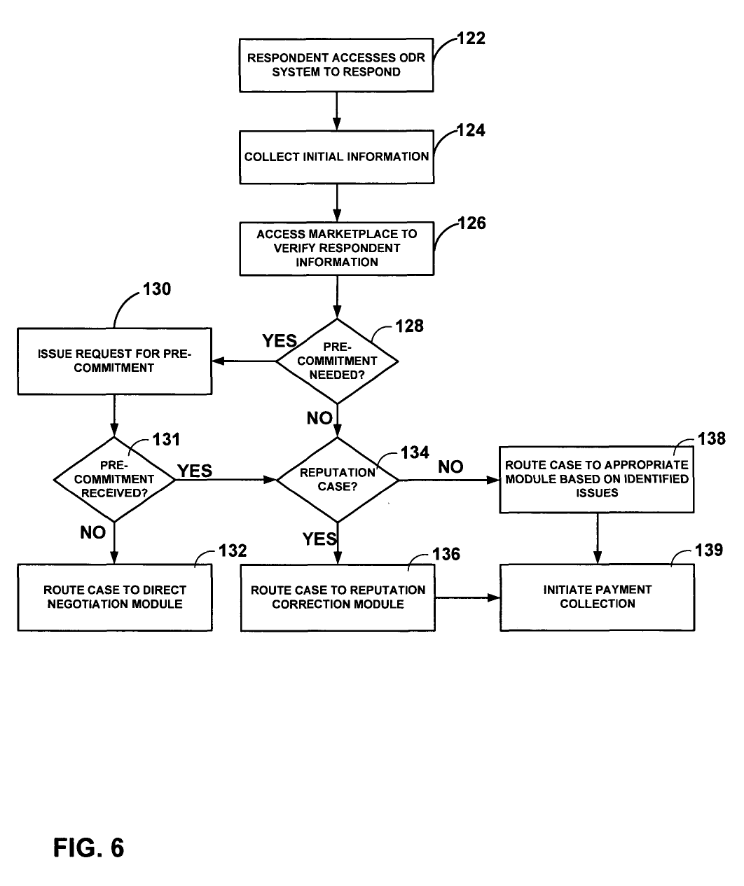

FIG. 6 is a flow chart illustrating an exemplary response process. Initially, a respondent accesses the ODR system 10 either through an email or through a password-protected page on the website that the user logs into, to respond to a dispute, or case, usually in response to an electronic message (122). Messaging management module 24 tailors communications to the responding party to present content and explanation of the dispute resolution process from various points of entry to online dispute resolution to encourage their participation. Message management module 24 may deliver communications to respondent in the form of escalating messages related to the consequence of non-response if a feedback/reputation dispute is involved.

ODR system 10 collects initial information about the respondent and about the disputed transaction (124). During this process, ODR system 10 provides an interface by which the respondent can view details about the case. Marketplace verification module 16 may access marketplace database 20 of online marketplace 18 where the disputed transaction occurred to independently verify certain details about the respondent transaction or to pre-fill information for confirmation by the respondent (126).

As describe above, ODR system 10 may tailor the information collection, issue identification and resolution identification processes based on the identity of the parties, the type of transaction, the sector of the marketplace, the value of the transaction, etc. The tailoring also includes automatically generating proposed issue clarifications and resolution suggestions based on precedence of similar cases. The tailoring might also recognize specific users that require other tailored processes that can include: submarketplace processes (e.g., eBay Motors), seal members with pre-commitments (which might present specific tailored messaging to a member to acknowledge their membership and pre-commitments), high volume users of a marketplace and repeat users of ODR (which might tailor messaging to represent their familiarity or scale of transaction or dispute activity).

Once the response is received, dispute resolution engine 30 processes the case. Dispute resolution engine 30 determines whether pre-commitment is required or is likely to advance the case (128). If so, message management module 24 issues a request to get pre-commitment from the respondent to participate in a specific process, for example, agreeing to remove a negative feedback or agreeing to participate in online mediation (130).

If the respondent declines the pre-commitment request (131), the case can be successfully processed and routed to a direct negotiation module 34A (132). In particular, message management module 24 then confirms the resolution process with the parties and routes them to direct negotiation, potentially with other options.

If however, the respondent agrees to pre-commit, the case is routed based on the identified issues. In particular, if the case is a reputation correction case (134), dispute resolution engine 30 routes the case to reputation correction module 34D (136). If the case is not reputation related or is not reputation only related, the dispute resolution routing engine 30 places the case in an appropriate queue for one of dispute resolution modules 34 based on the identified issues (138). At this time, a payment process (139) is initiated, if appropriate. Throughout this processes, dispute resolution database 12 is continuously updated with each event associated with a case.

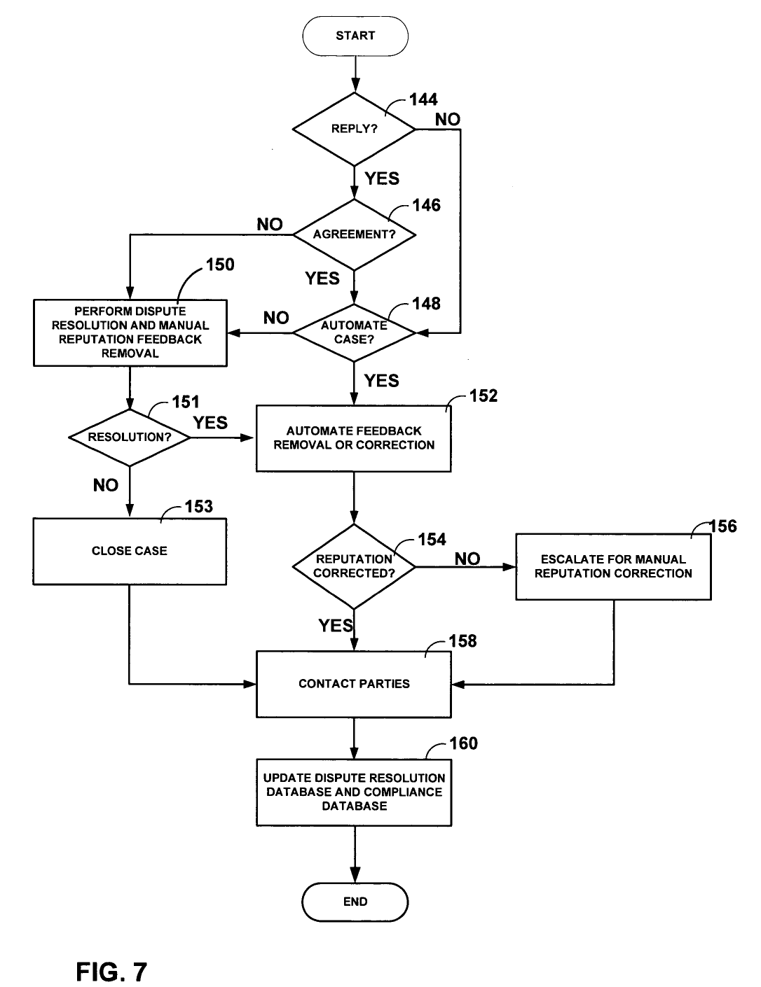

FIG. 7 is a flow chart illustrating an exemplary reputation correction process performed by reputation correction modules 34D. Based on whether or not the other party has responded to the case (144), reputation correction modules 34D processes the case as either a non-response case or a case where both parties are participating.

If the respondent has responded to the filed case, reputation correction module 34D first makes a determination as to whether the parties have agreed to a resolution, e.g., a resolution suggested by ODR system 10 when the case was filed or a resolution reach during direct negotiation (146). In particular, ODR system 10 makes a determination as to whether the parties have agreed to remove or correct the feedback or agree to engage in resolution related to the feedback removal. The feedback may relate to, for example, a feedback rating provided within electronic marketplace 18 by one of the parties with respect to the disputed transaction. If the responding party agrees to remove or change the feedback under dispute, the reputation correction module tests the case to confirm whether online marketplace 18 rules allow the process to be closed with an automated process (148) versus requiring utilization of a DRS module. In general eligibility applies in specific conditions, such as feedback left by mistake or feedback is the only issue involved in the dispute.

Otherwise the reputation correction module 34D directs routing engine 32 to manually or automatically route the case to manual dispute resolution or validation of feedback removal (150). Specifically, if manual dispute resolution is required or if the parties do not agree to the resolution in the filing or direct negotiation process, the dispute resolution specialist 10 facilitates resolution including reputation repair or removal. This can also include a case of non-response where the filer's case is reviewed by the dispute resolution specialist to validate if their feedback or reputation issue can be corrected under non-response rules.

If the process is automated or if the parties agree to reputation repair, similar processes reputation correction module 34D interacts with electronic marketplace 18 to automate the removal or correction of feedback initially provided by one or both of the parties (152). Reputation correction module interacts with electronic marketplace 18 to verify the automated reputation correction (154). If the reputation has not been correction, reputation correction module 34D escalates the process for manual correction (156). Message management module 24 continuously updates the parties throughout the process.

If the parties do not agree (151) or if the reputation does not pass automatic correction rules, reputation correction module 34B closes the case without updating or modifying the feedback (157). Message management module 24 contacts (156) the relevant parties 4, including, for example, the filer and the respondent, as well as online marketplace 18, and verification and compliance system 16. Finally, reputation correction module 34D updates dispute resolution database 12 and compliance database 17 based on the resolution, i.e., whether or not the dispute has been resolved and the feedback has been updated or corrected (160).

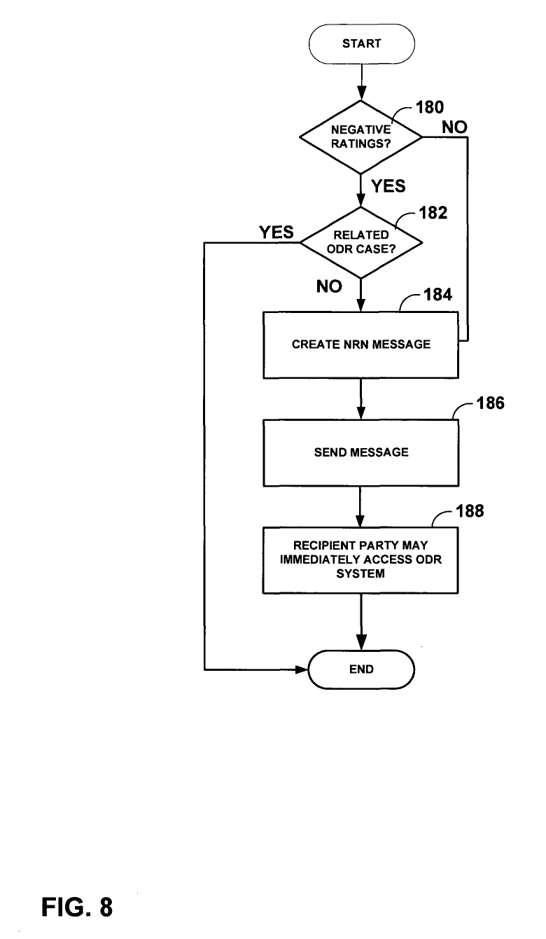

FIG. 8 is a flow chart illustrating an exemplary process performed by negative reputation notification (“NRN”) module 26. Specifically, NRN module 26 periodically accesses or otherwise monitors member compliance database 17 to identify any recently posted negative reputation ratings (180). As described above, compliance database 17 may be periodically synchronized, e.g., daily, with marketplace database 20 and reputation database 19 of marketplace 18. NRN module 26 may present an interface via web server 15 by which a system administrator or other user may set thresholds or parameters for use in filtering an identifying such negative reputation ratings from compliance database 17 or reputation database 19. If no negative or reputation ratings exist, the process ends.

If NRN module 26 identifies a newly posted negative reputation rating, the module checks dispute database 12 for an online dispute resolution case or online dispute resolution involving the transaction from which the negative reputation rating arises (182). If a case does not already exist, NRN module 26 creates a negative response notification message based on specified parameters (184). The system administrator may set and/or adjust the specified parameters, for example, based on marketplace rules. Alternatively, NRN module 26 may automatically adjust the specified parameters based on user settings.

NRN module 26 issues the message (186), e.g., as one of a batch of electronic message notifications to the associated party 4 having a negative reputation rating. The message contains links, e.g., hyperlinks, for accessing ODR system 10. As a result, the online entities, i.e., parties 4, who received a negative reputation notification are linked to or otherwise associated with an online dispute resolution process involving the reputation rating. Online entities may link to a customized reputation dispute resolution filing process and given access to the online dispute resolution database 12 to easily and quickly take action based on the newly received negative reputation (188).

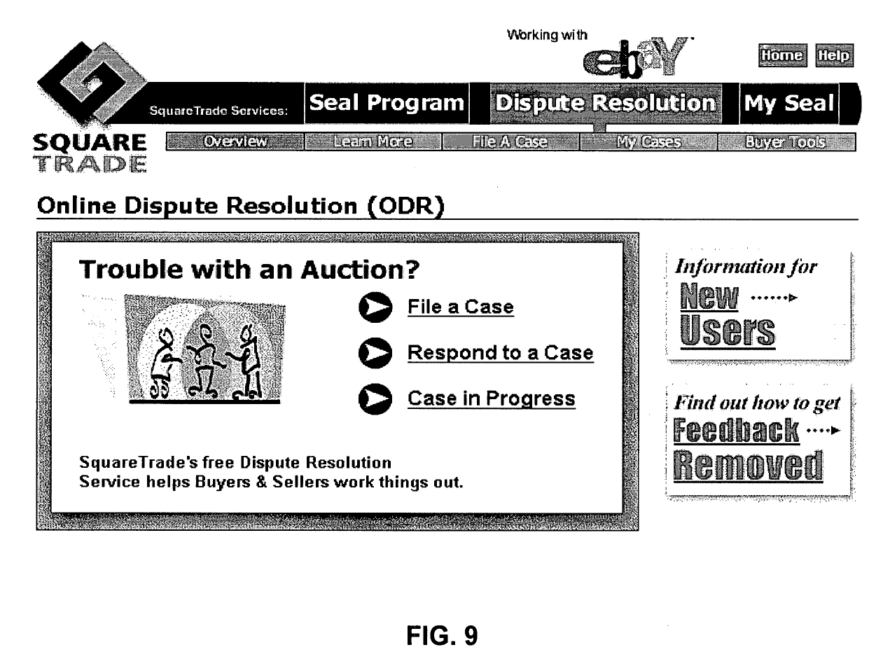

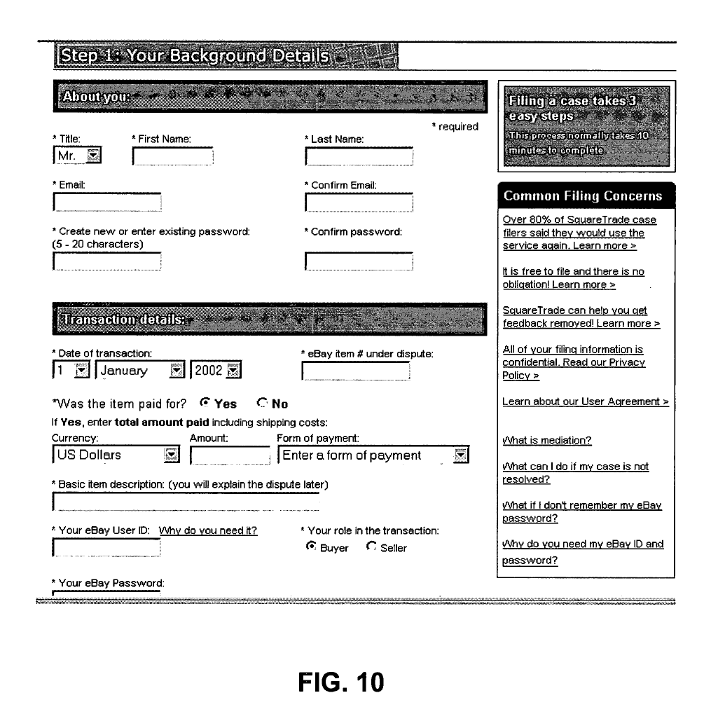

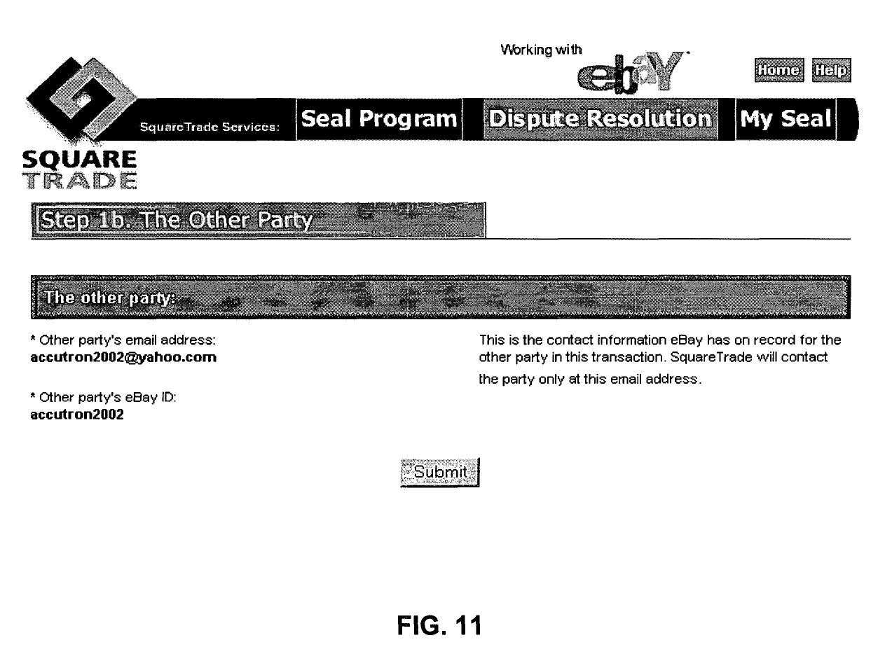

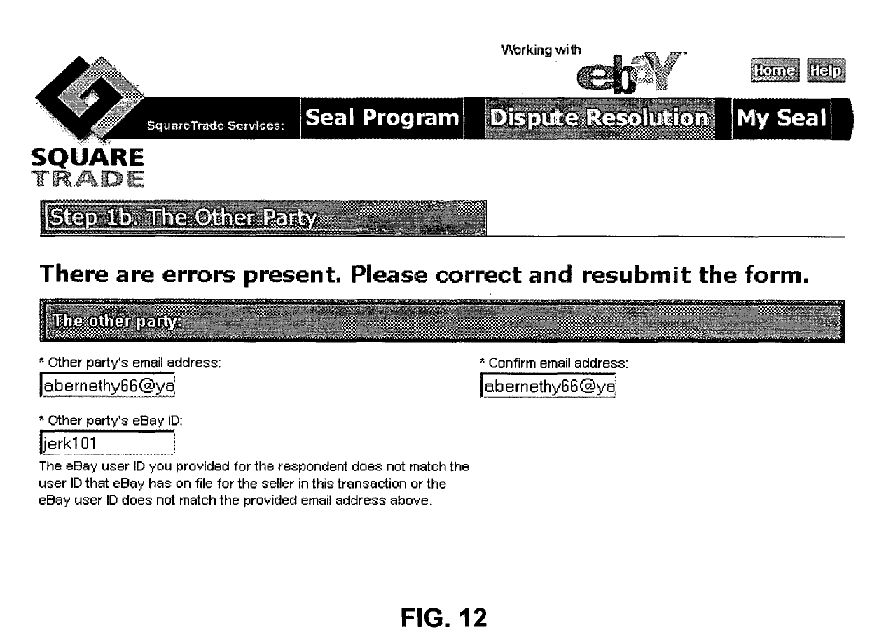

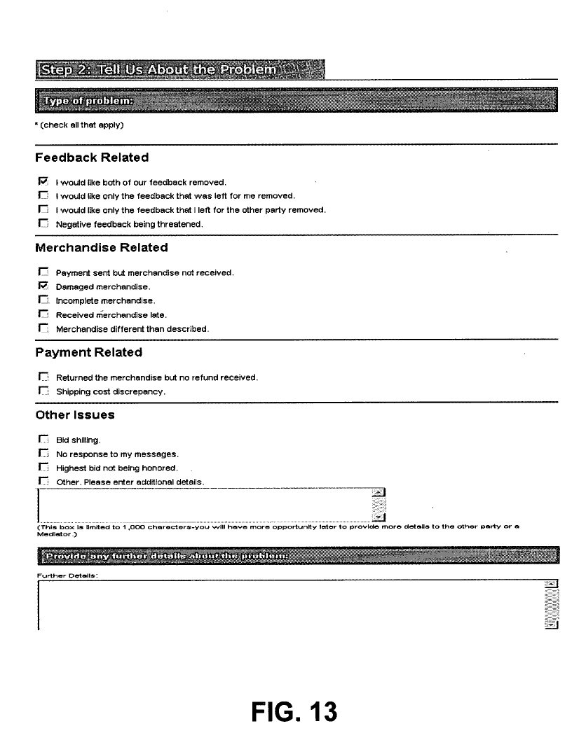

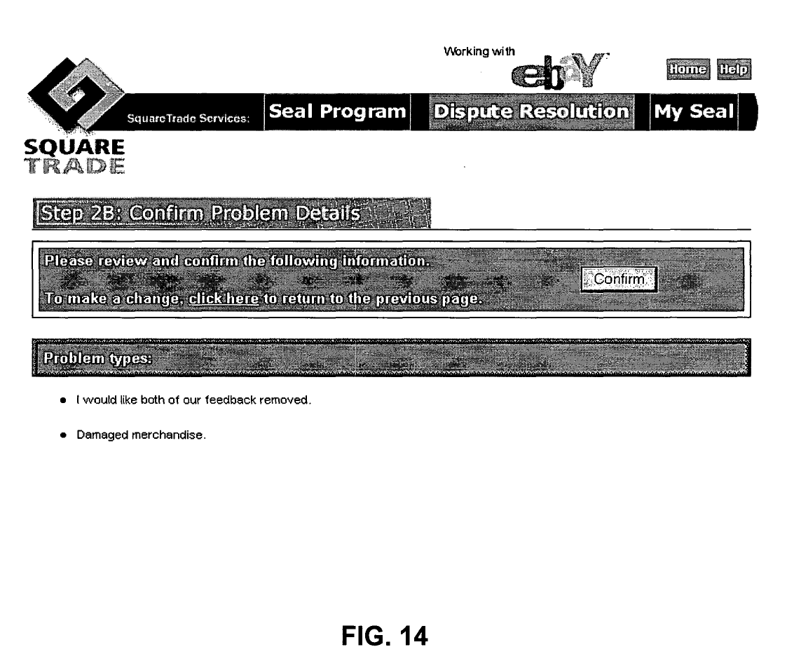

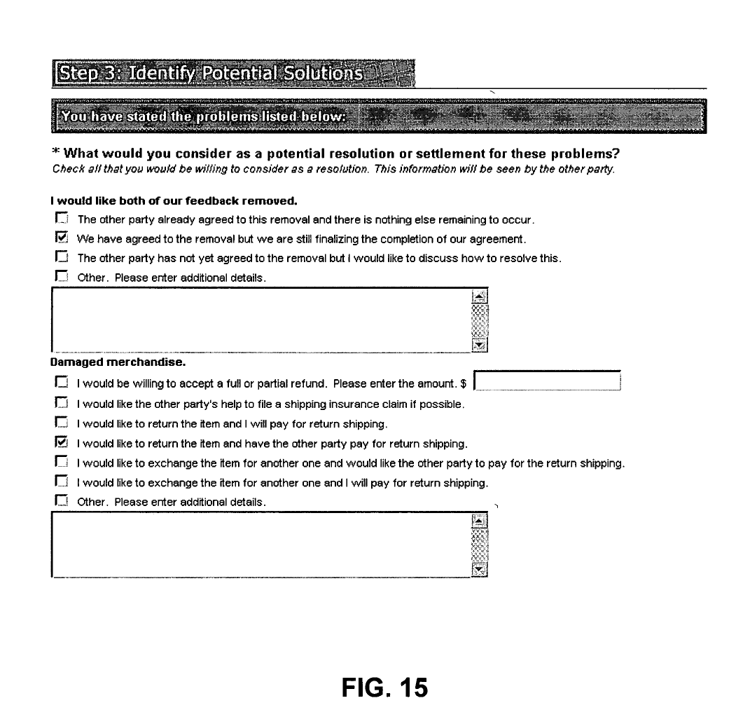

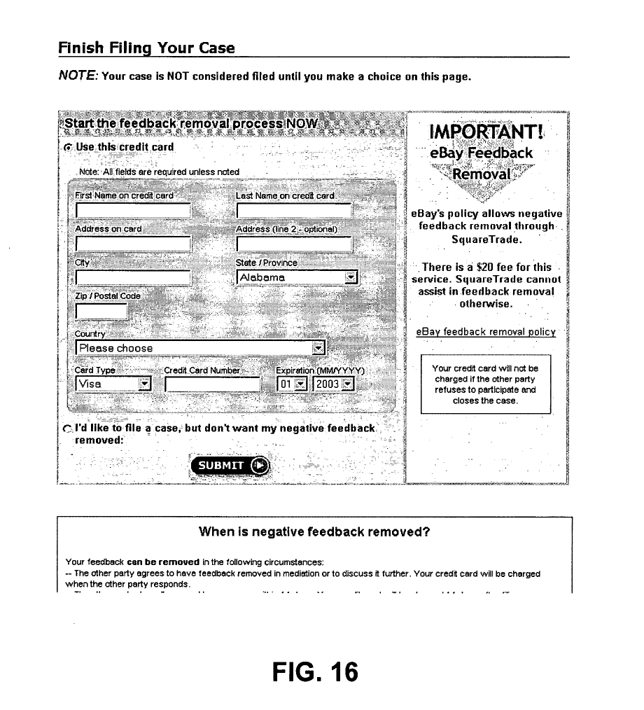

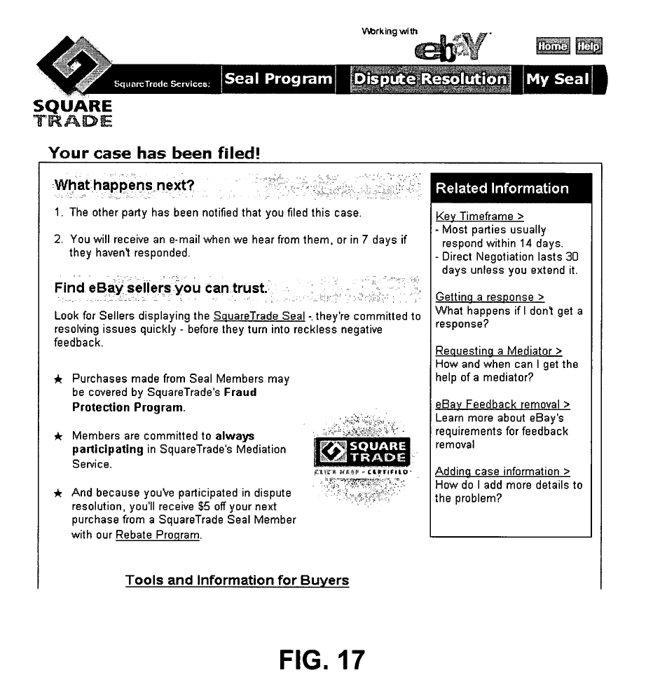

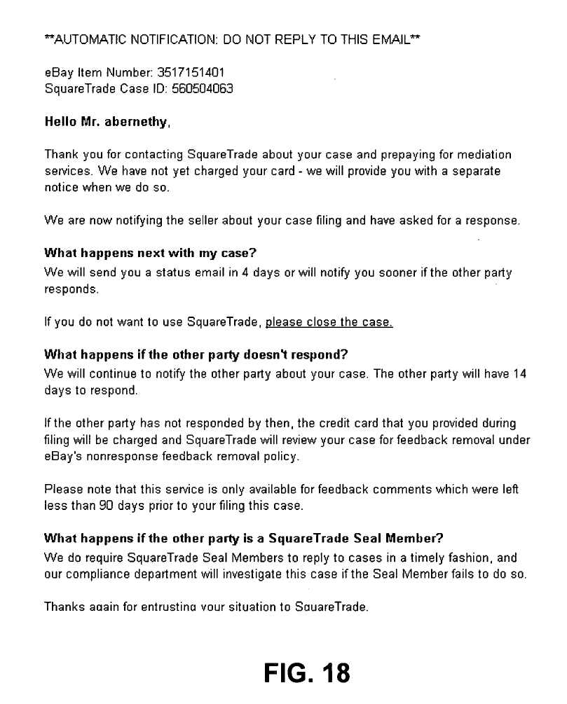

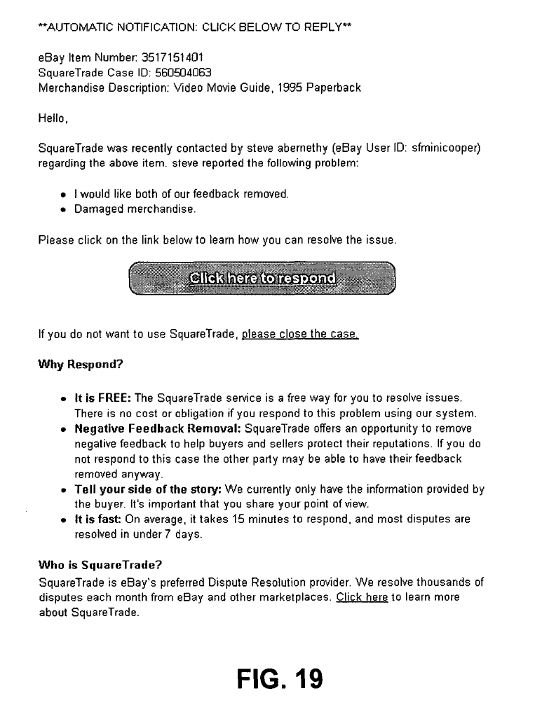

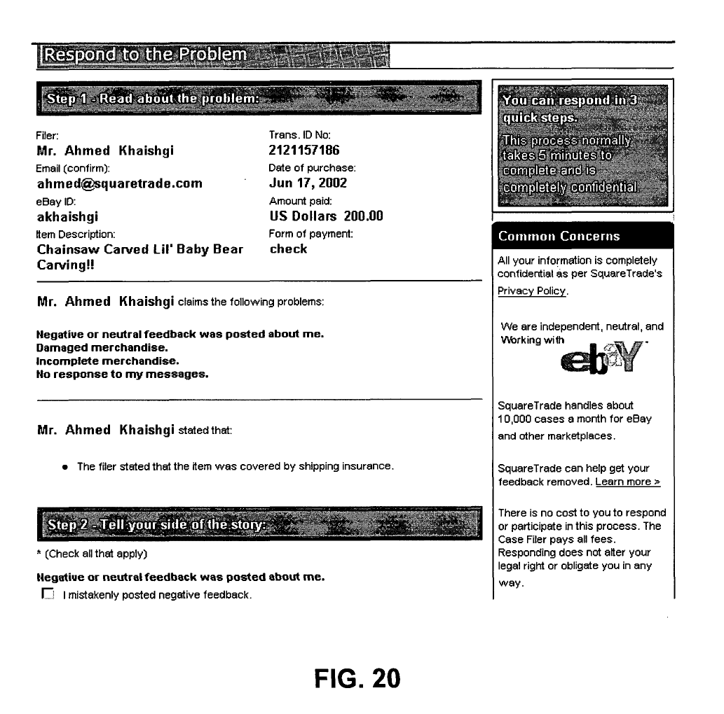

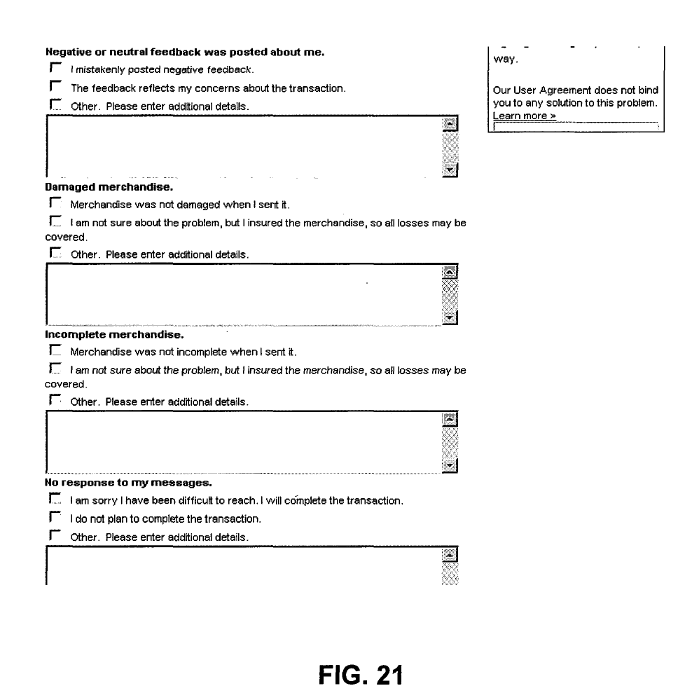

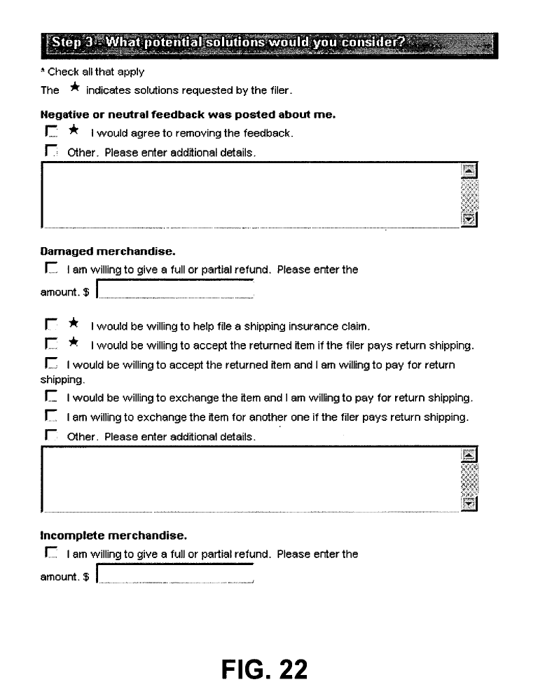

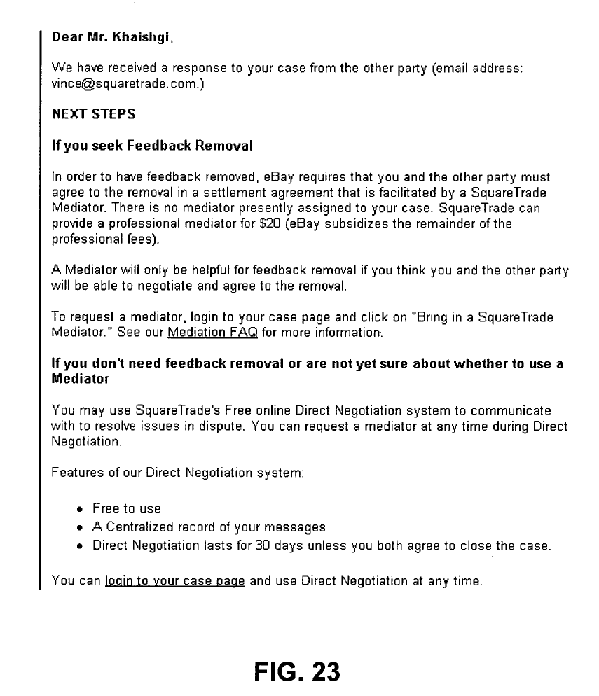

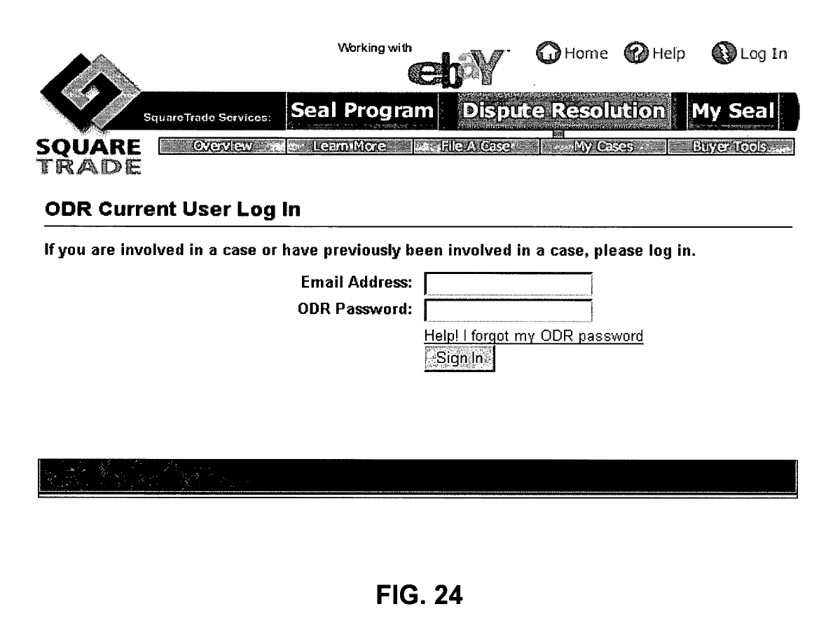

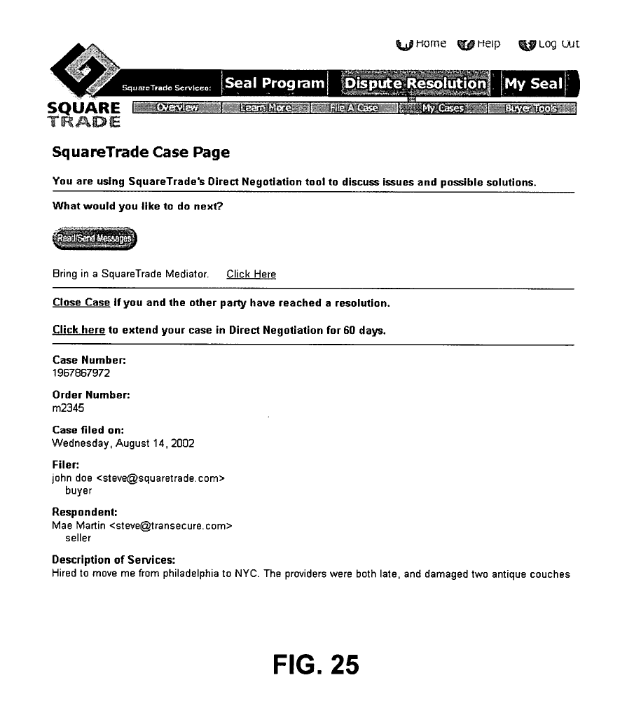

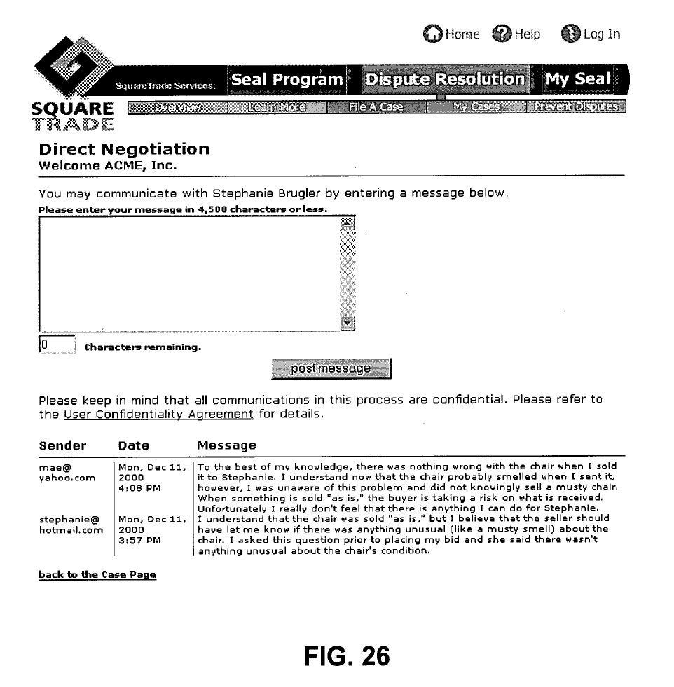

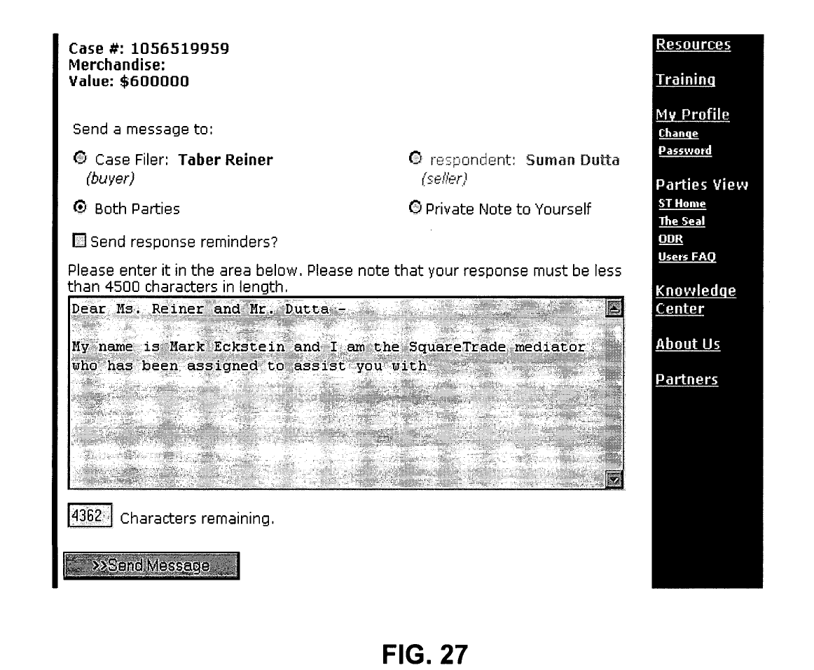

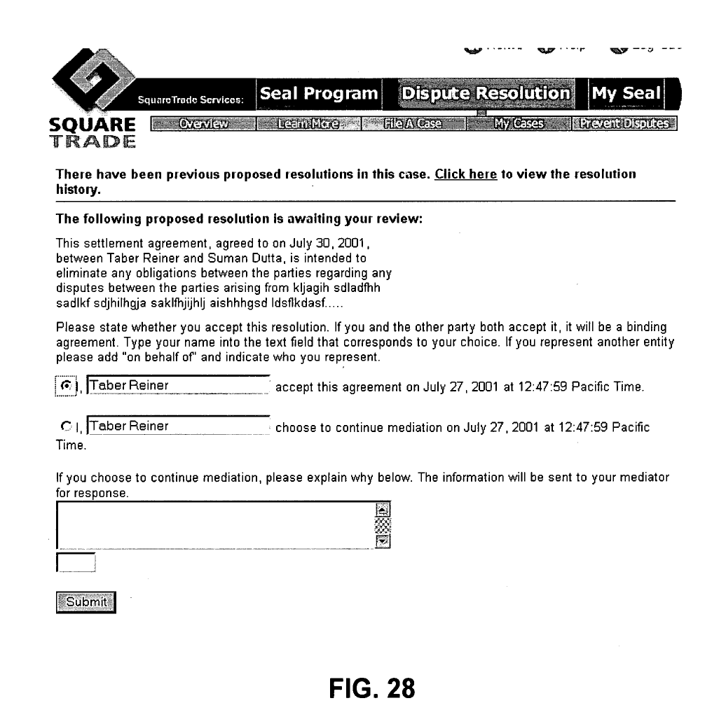

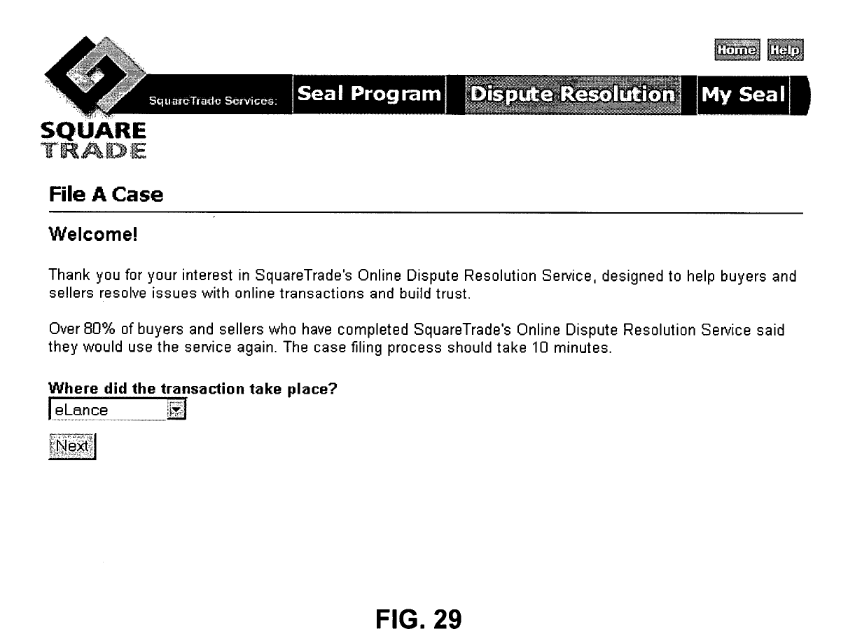

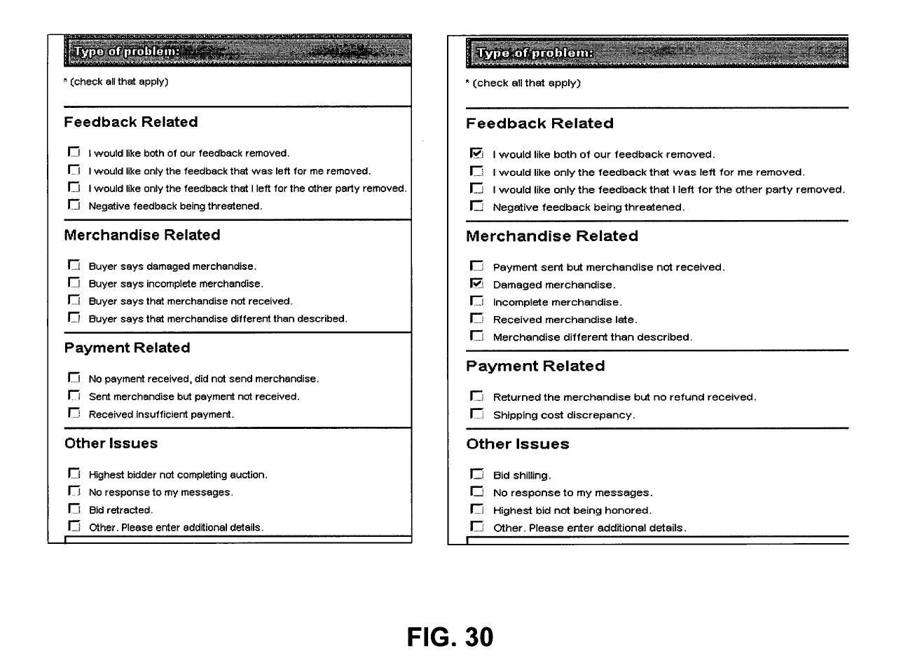

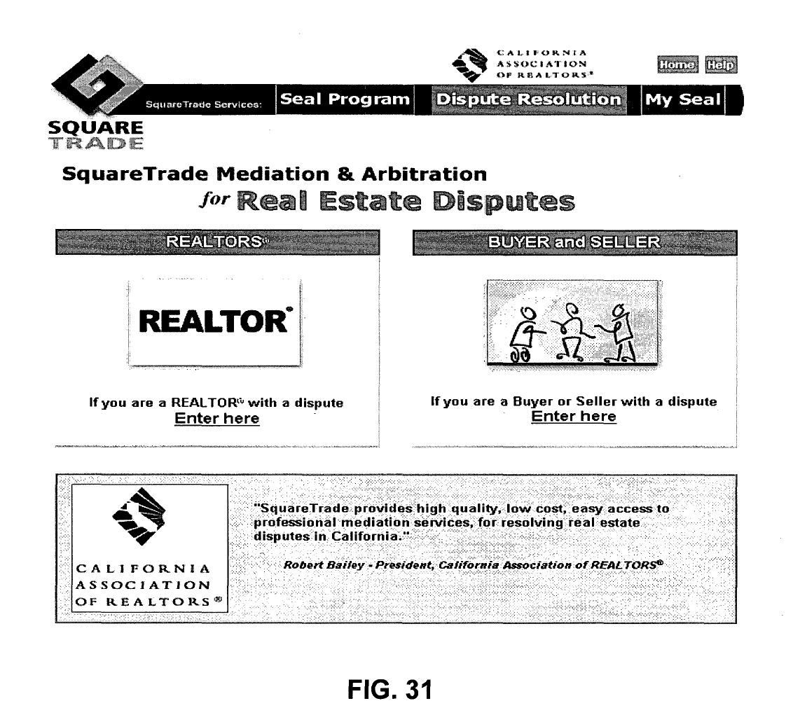

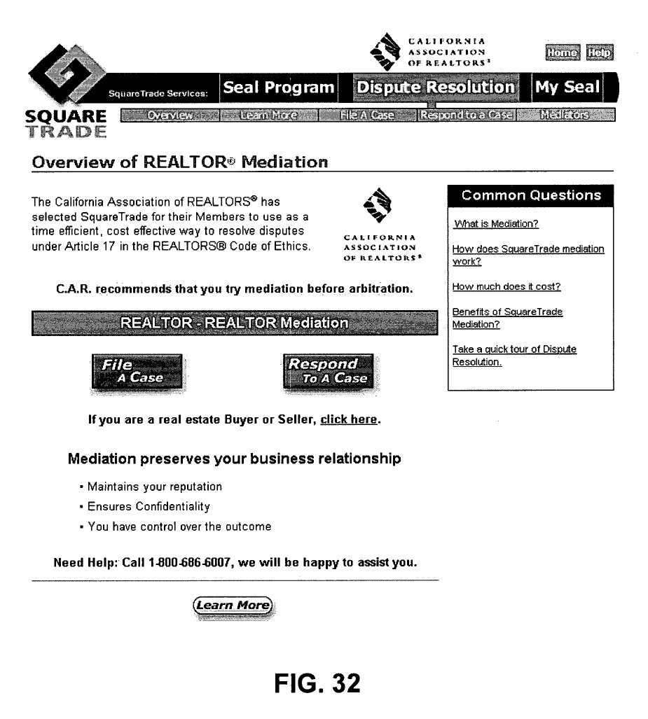

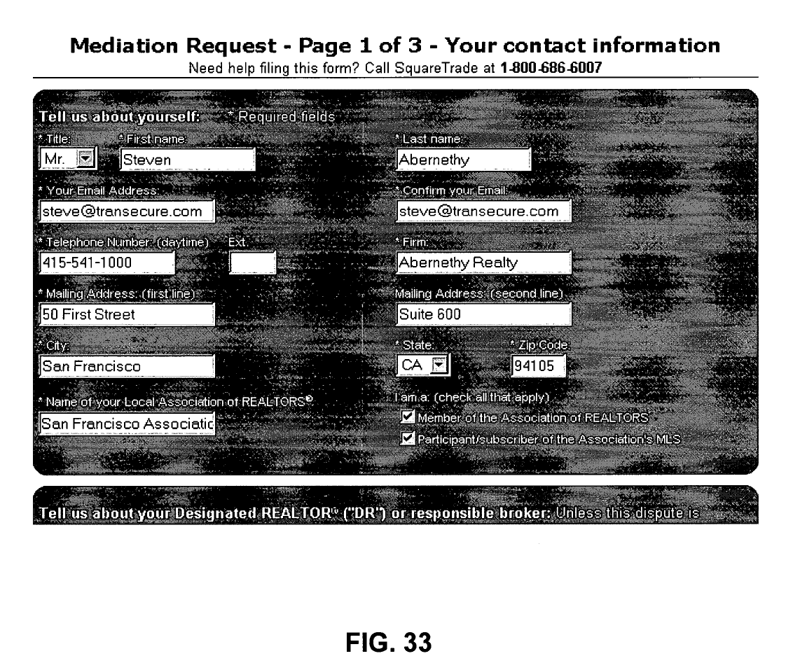

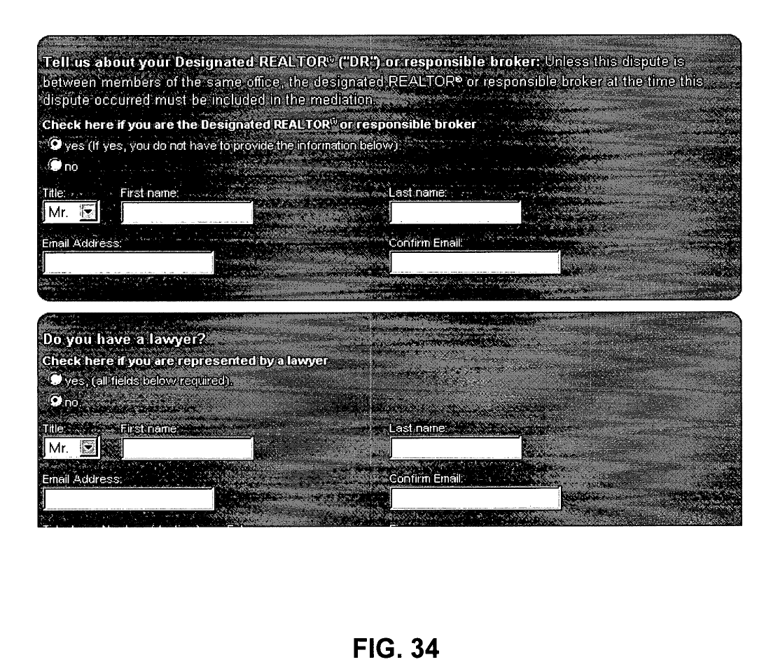

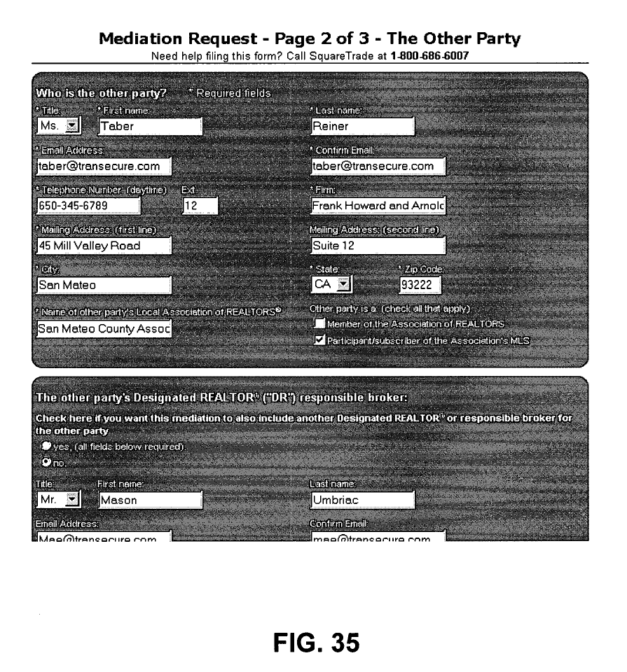

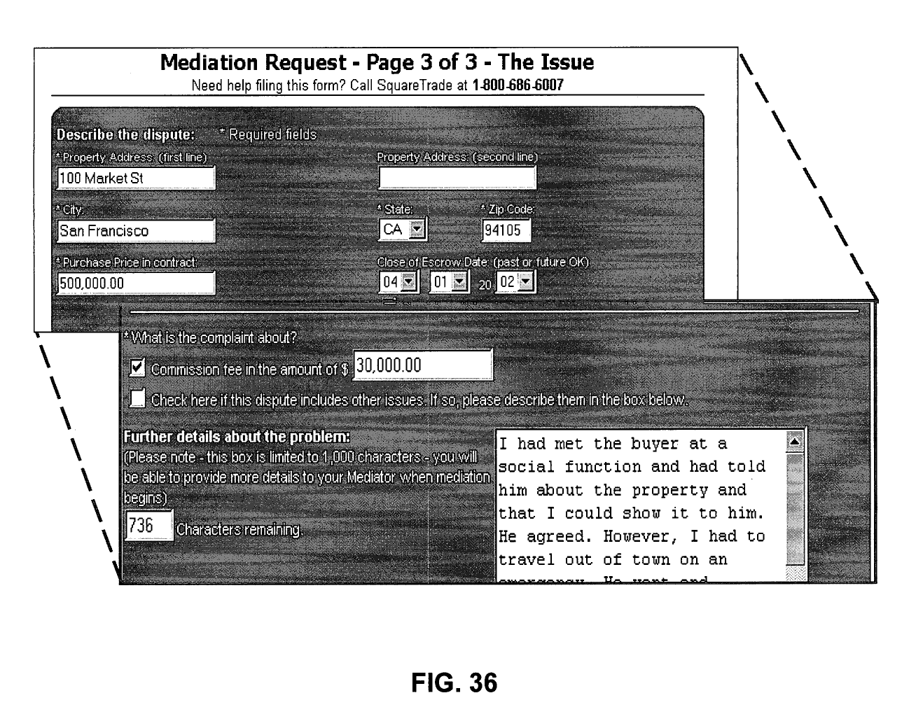

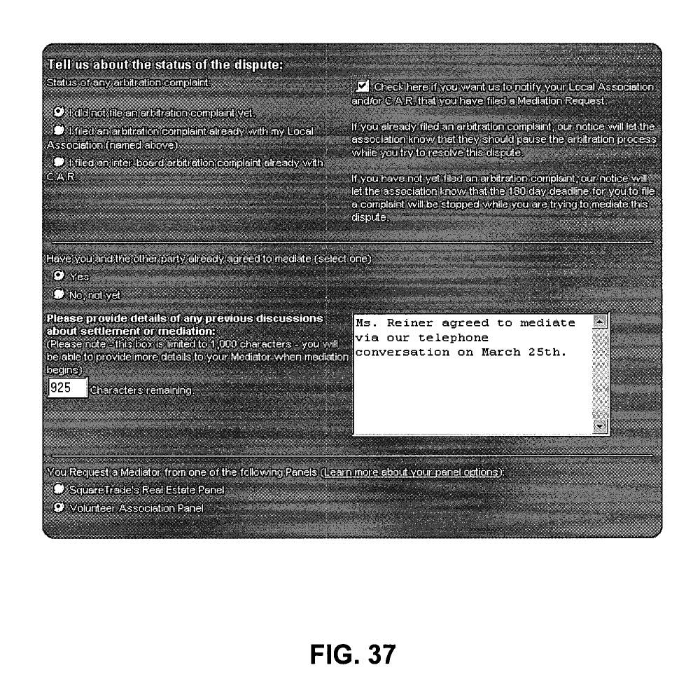

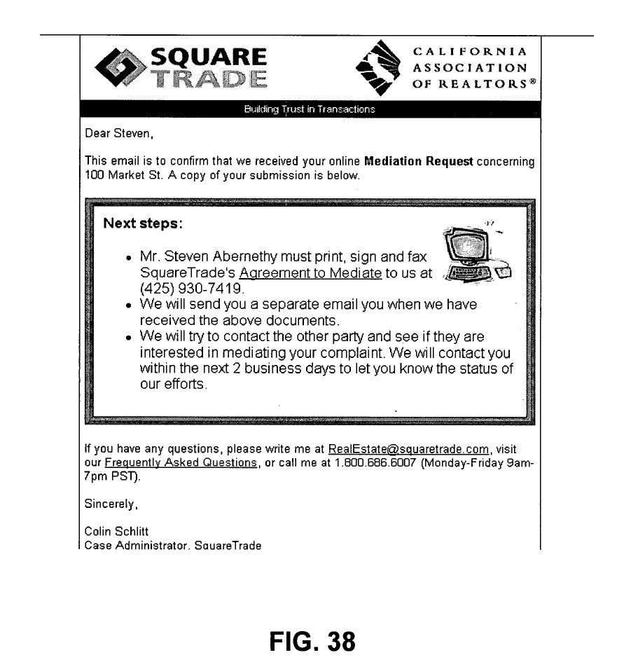

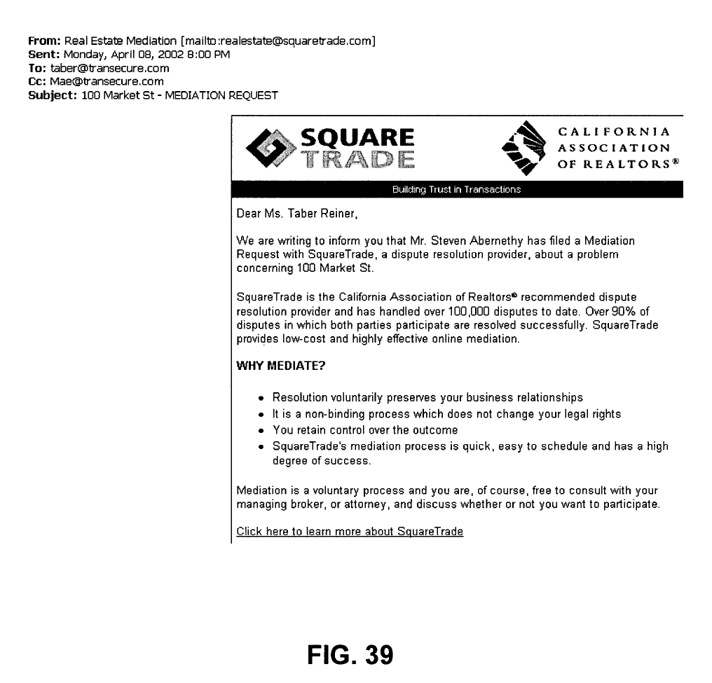

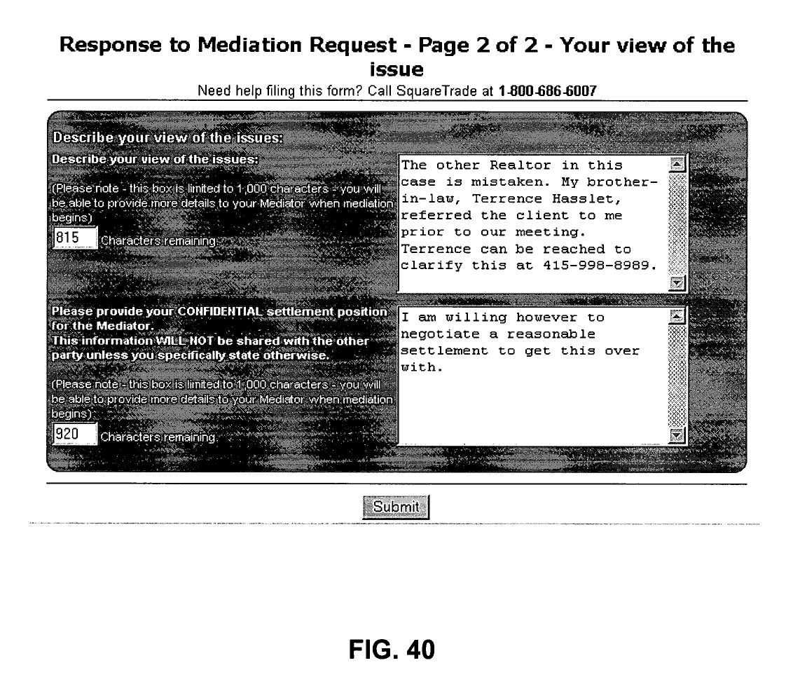

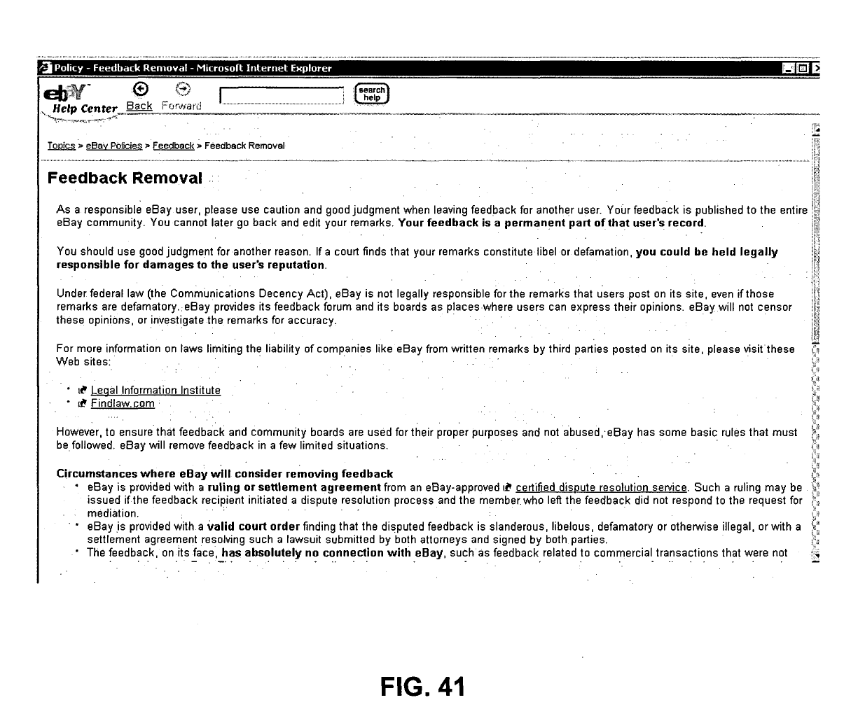

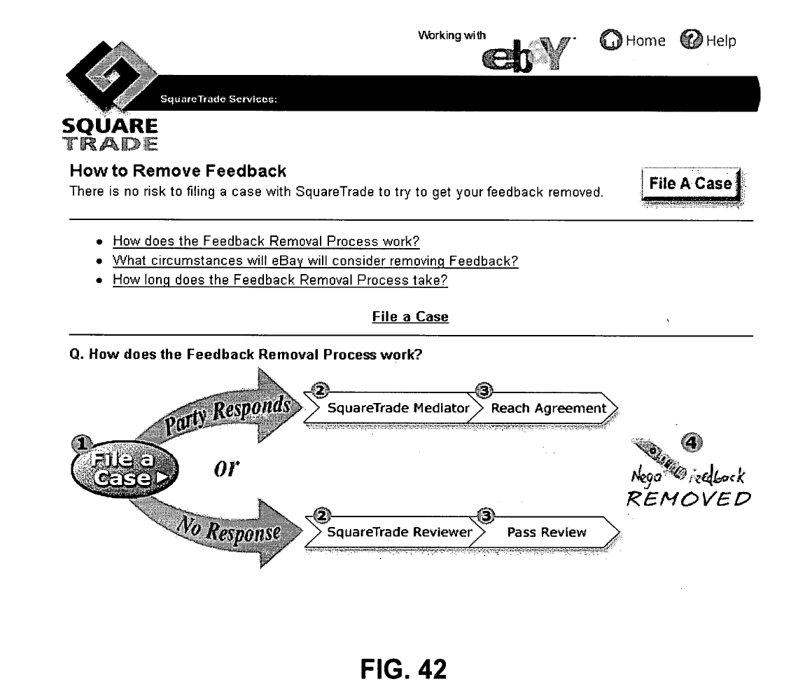

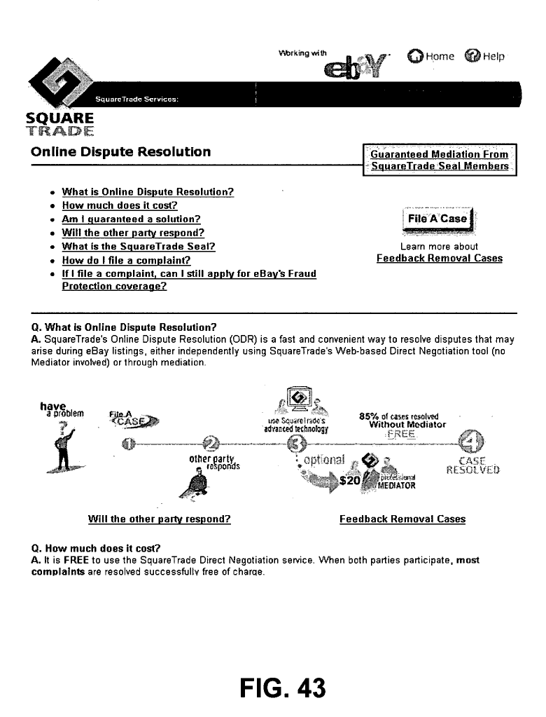

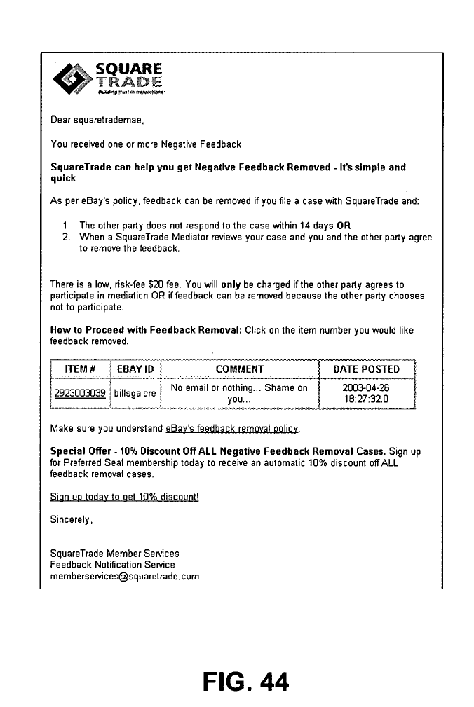

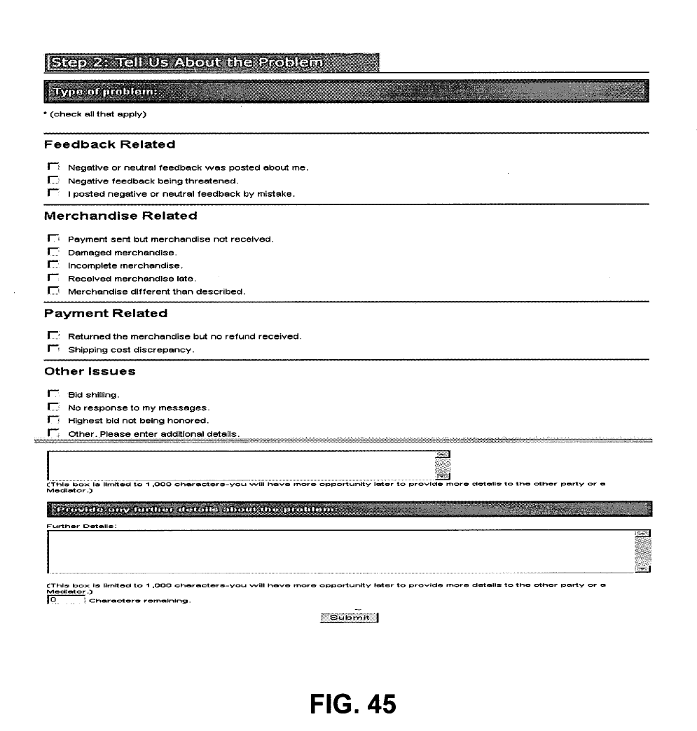

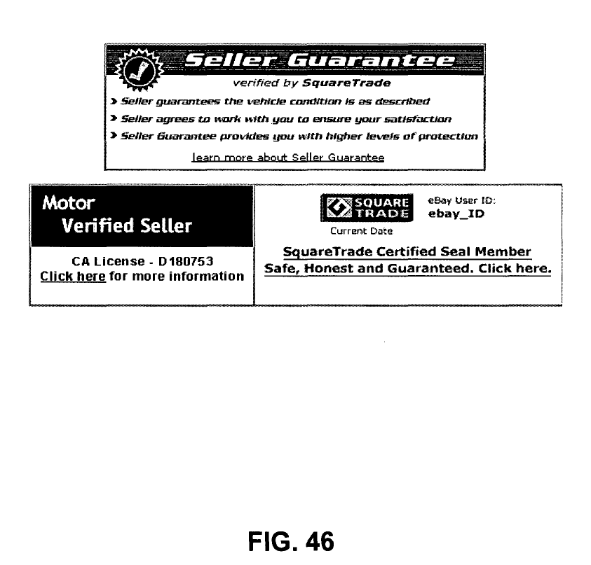

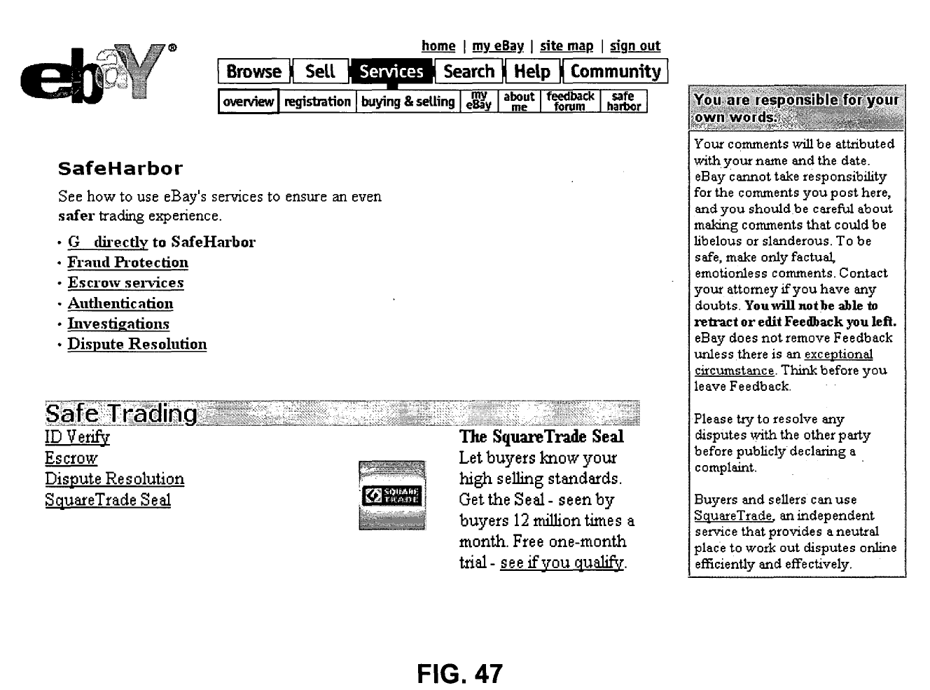

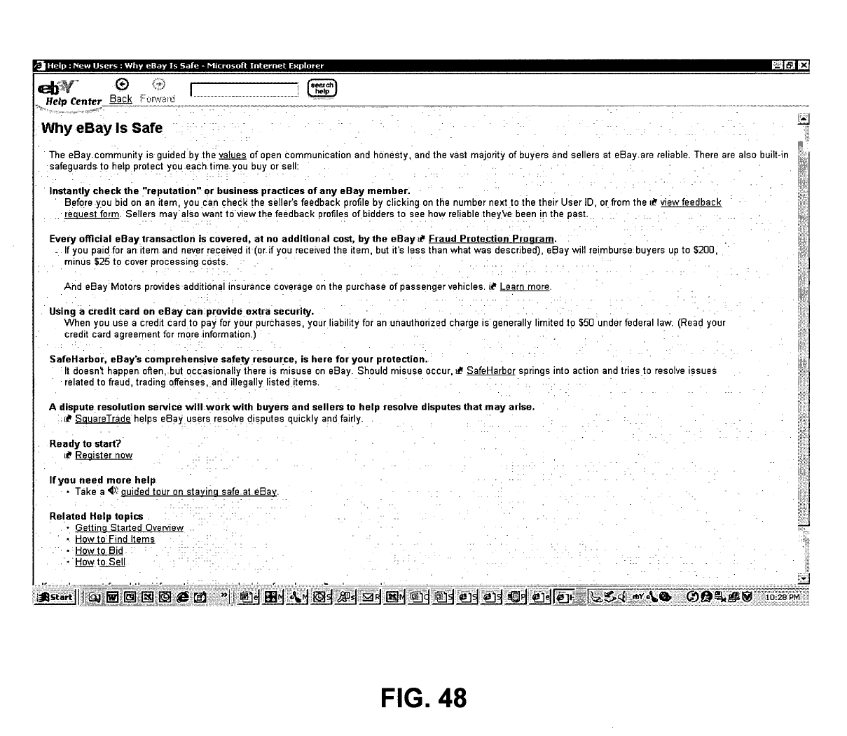

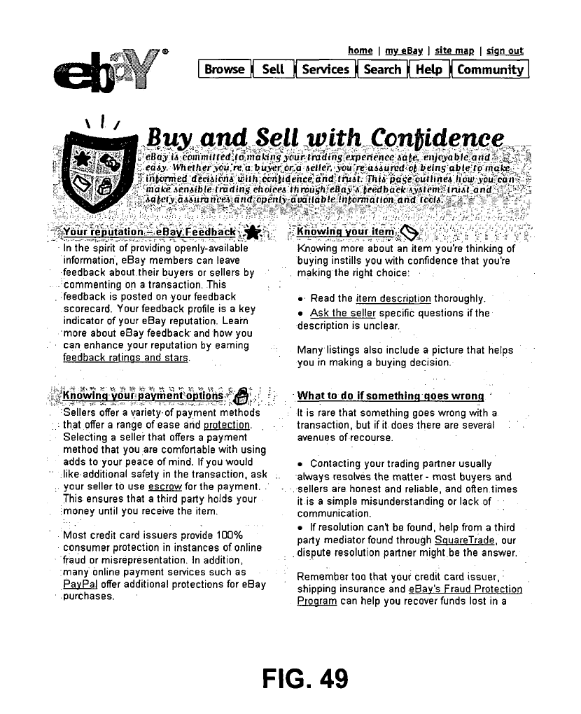

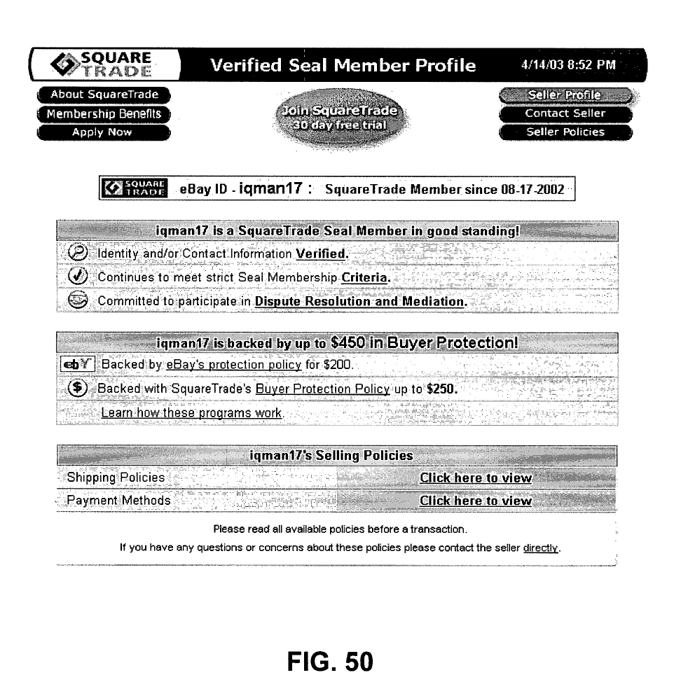

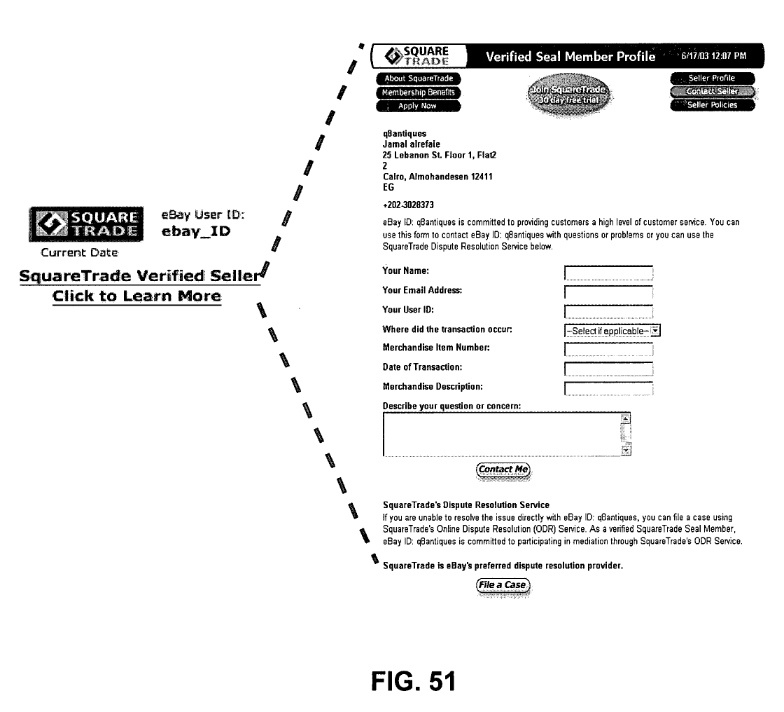

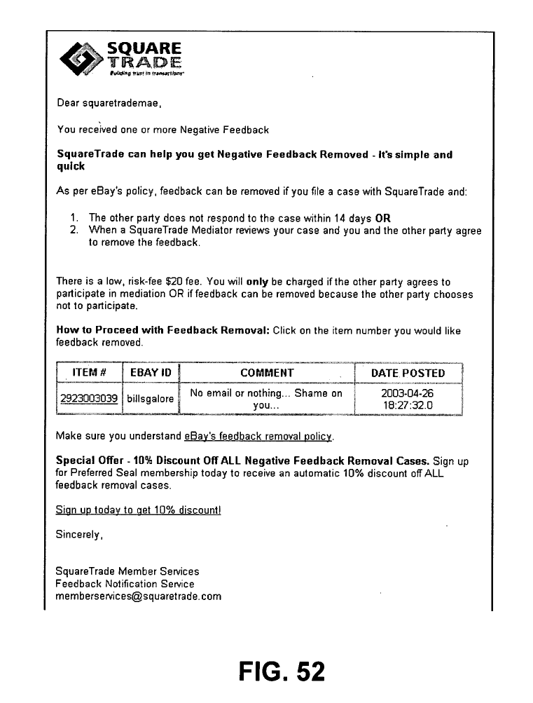

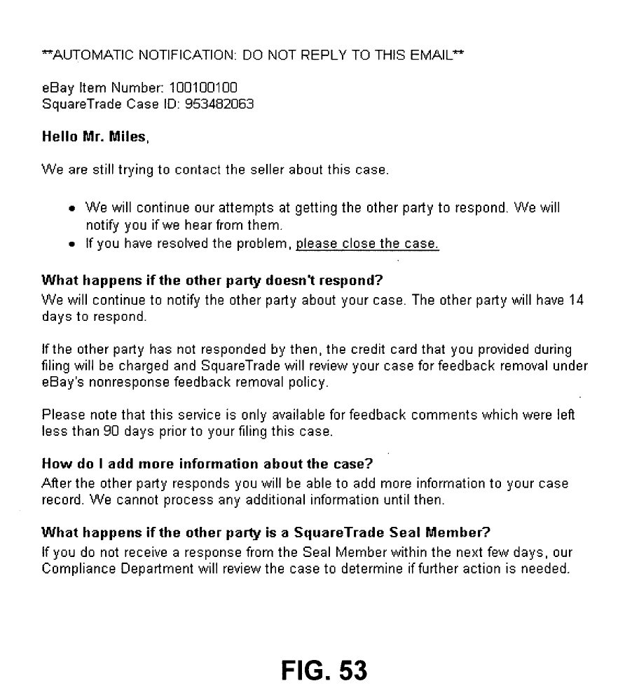

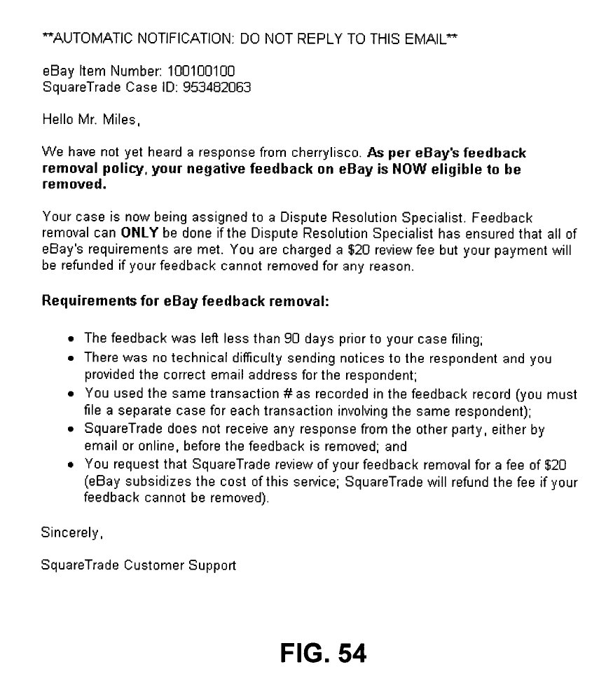

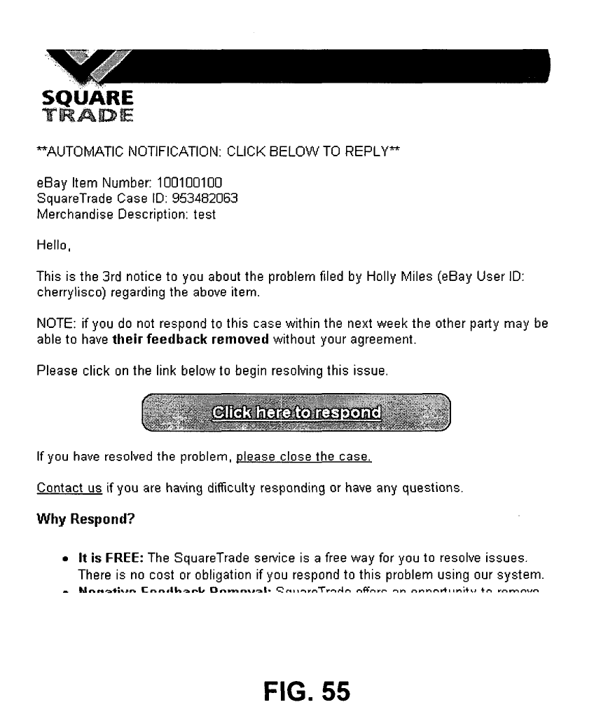

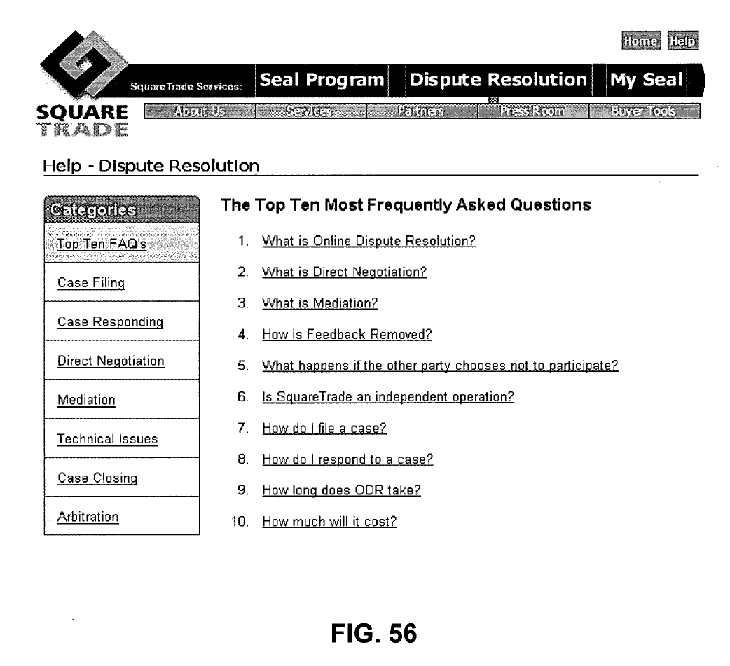

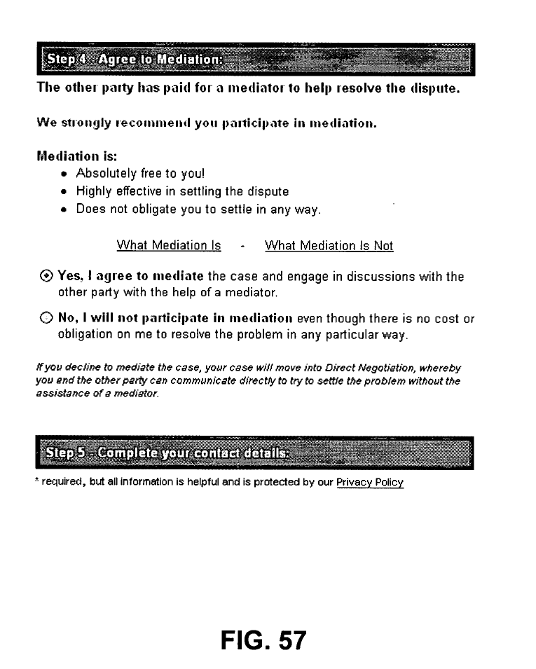

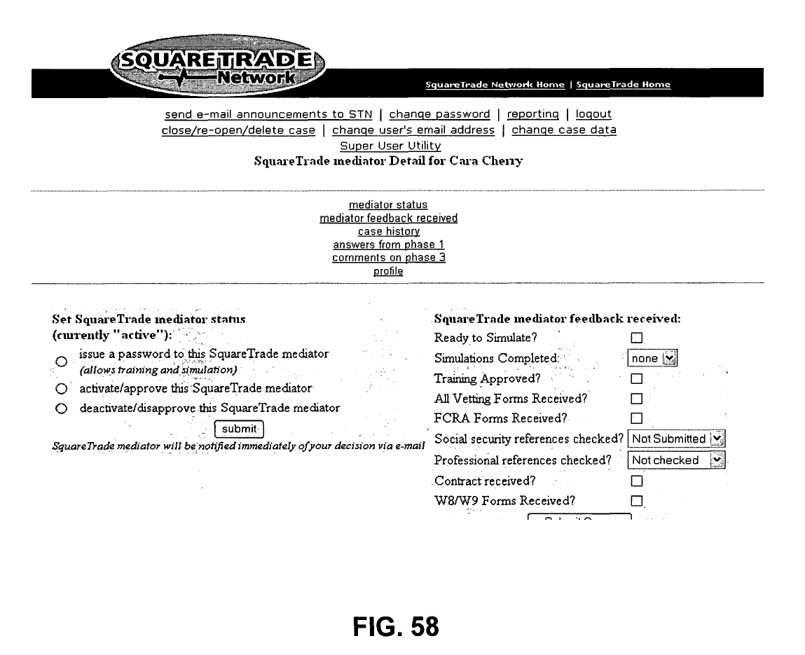

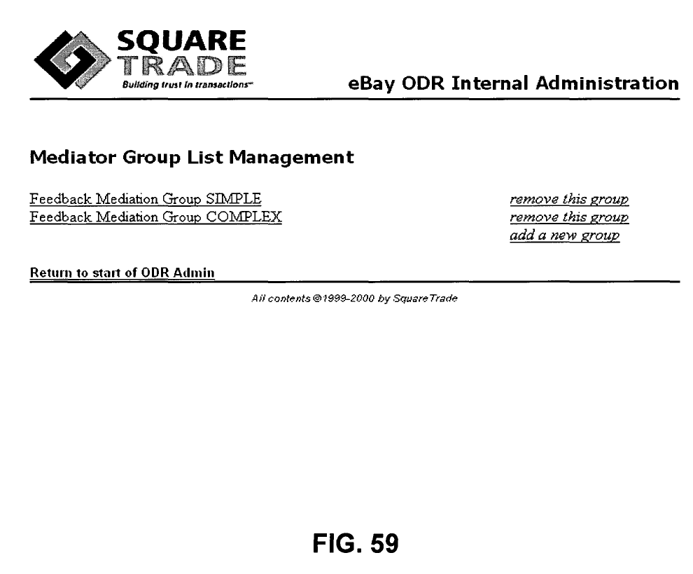

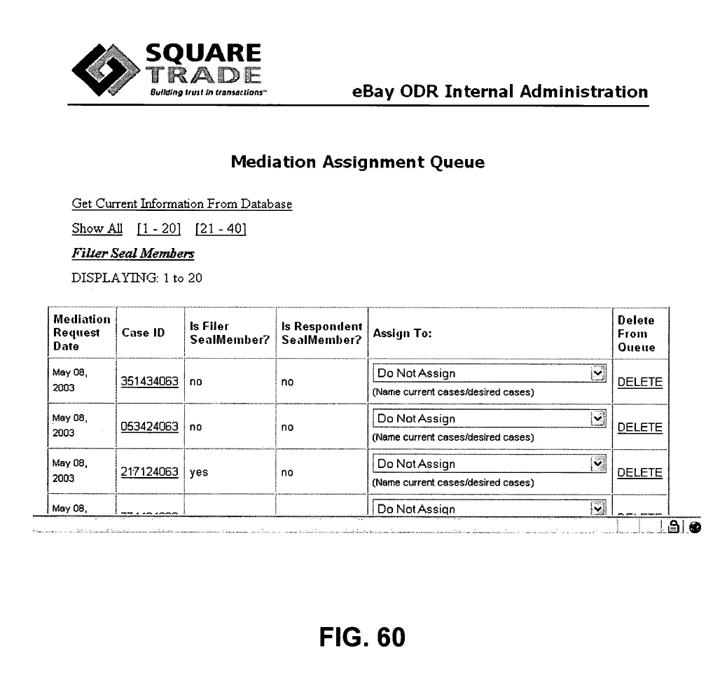

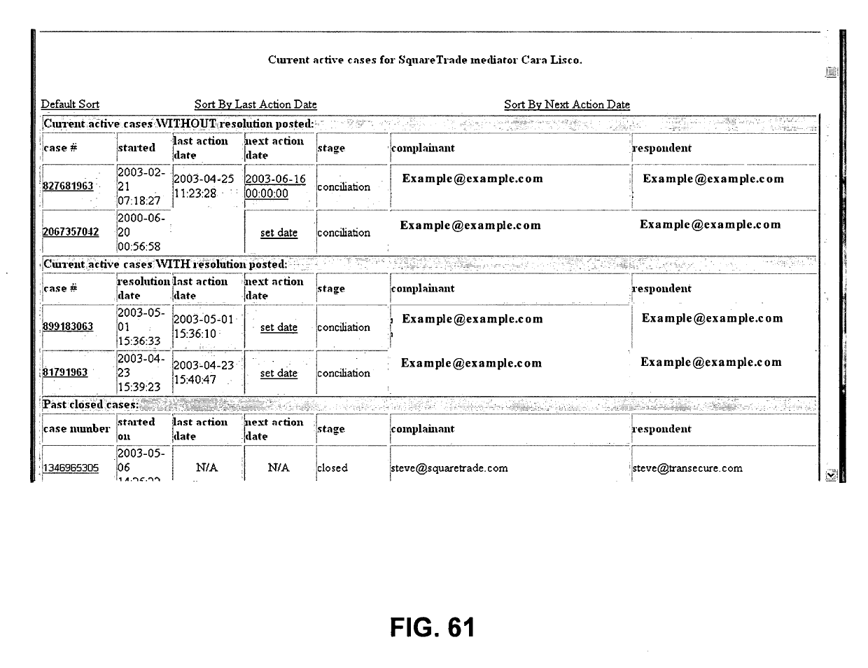

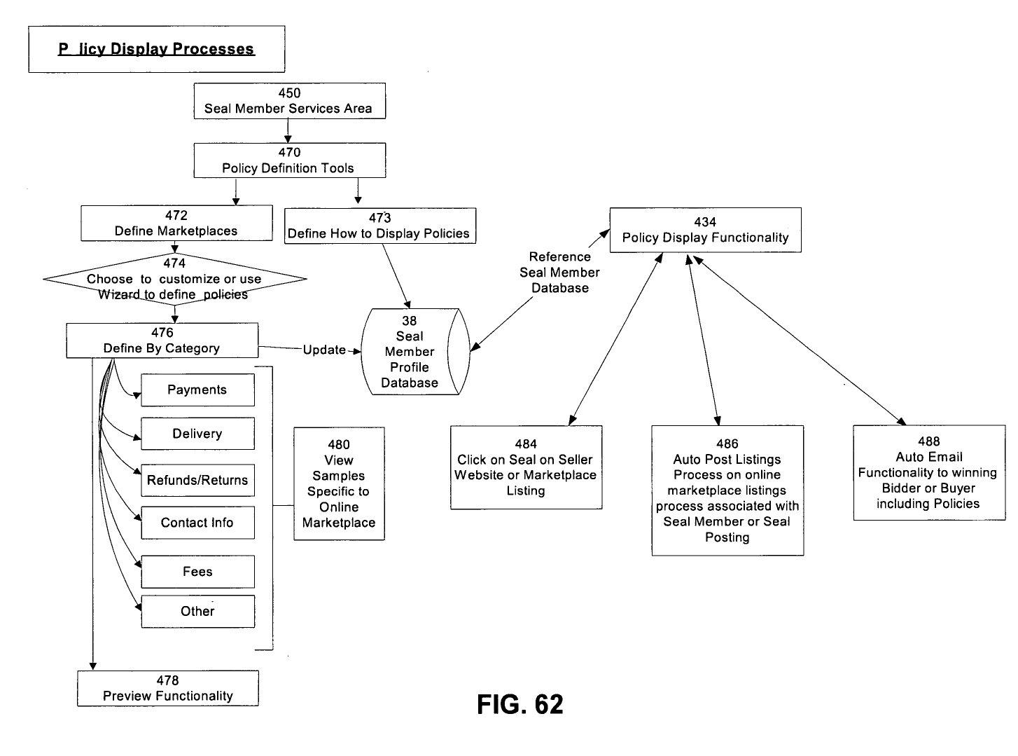

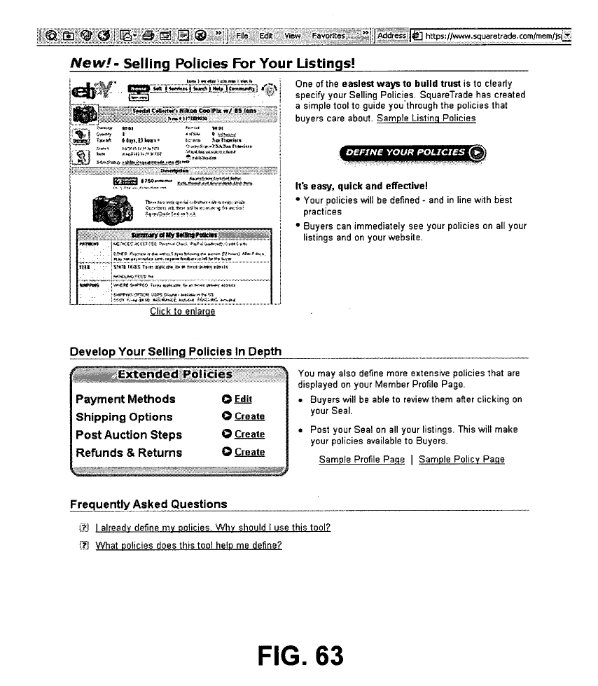

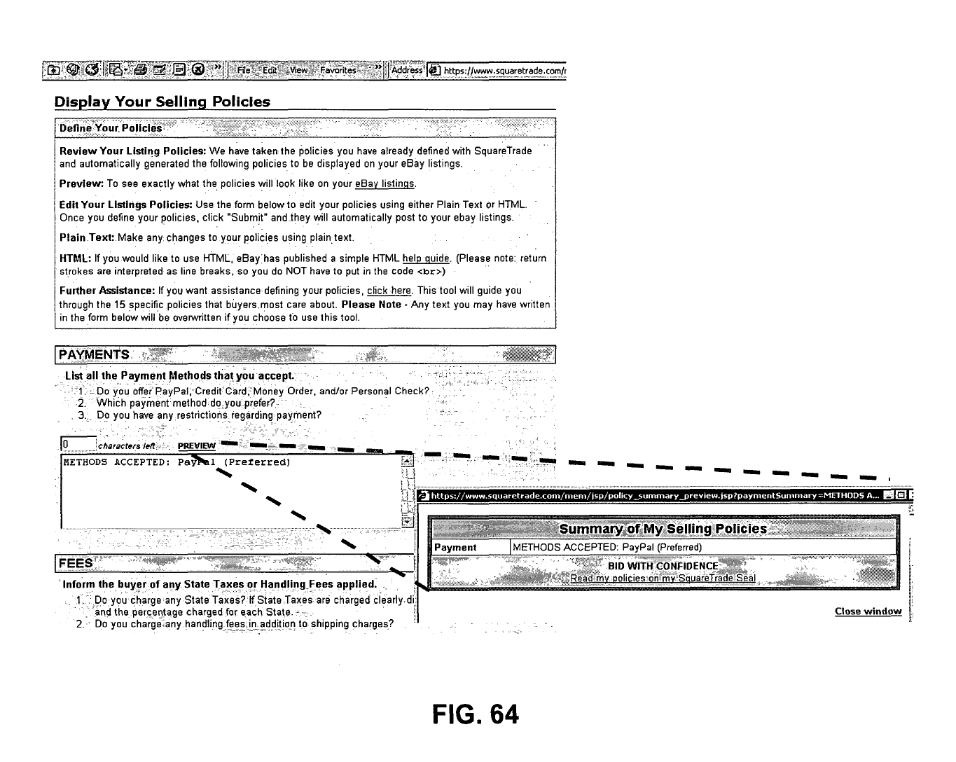

FIG. 9 is a screenshot of an exemplary interface presented by ODR system 10 as specific to an exemplary marketplace 18. FIG. 10 is a screenshot illustrating information gathering in the filing of a case in the ODR system 10. FIG. 11 and FIG. 12 illustrate examples of automated validation and pre-filling of input information through automated communication with an online marketplace. FIG. 13 illustrates a tailored issue clarification process based upon earlier parameters in the case and precedence based on these issues. FIG. 14 illustrates confirmation processes used throughout to ensure accuracy of data submitted in each step. FIG. 15 illustrates a tailored resolution clarification process based upon earlier parameters and issues identified in the case and precedence based on these factors. FIG. 16 illustrates an automated and timed pre-payment information request and pre-authorization process. FIG. 17 and FIG. 18 are screenshots illustrating a confirmation that a case is been filed.

FIG. 19 is a screenshot illustrating a communication to the respondent of the case having been filed. FIG. 20, FIG. 21 and FIG. 22 are screenshots illustrating a response process to be completed by the respondent, including reviewing the facts of the transaction and filer, issue clarification, and resolution identification. FIG. 22 illustrates how highlighting techniques are used to identify agreement or disagreement associated with desired resolutions.

FIG. 23 is a screenshot illustrating an electronic message to notify the parties concerning progress relative to the online dispute resolution case. FIG. 24 is a screenshot illustrating a the password protected user logon for one or more of the parties involved in the dispute to access a case page which is illustrated in the screenshot of FIG. 25. FIG. 25 illustrates the several modes users can access including: engaging in direct negotiation through “read/send messages”, requesting a mediator, closing a case, and extending a case.

FIG. 26 is a screenshot illustrating an asynchronous communication tool encouraging or facilitating confidential direct negotiation between the parties. Each time a message is left by either party in this confidential communication area, parties receive notification to return to the case page. FIG. 27 is a screenshot illustrating communication tools utilized by a dispute resolution specialist, for example a mediator, responsible for mediating a dispute. The screenshot shows functionality allowing both private and public functionality between one or both parties. FIG. 28 illustrates a suggested mediation settlement agreement that a dispute resolution specialist proposes that each party must click to accept in order for case to close.

FIG. 29 is a screenshot illustrating an entry from online marketplace 18 into dispute resolution system 10. The system allows a different experience for each marketplace as chosen by the user. FIG. 30 is a screenshot illustrating how the user experience (in this case the issue identification process for the filer) is customized based on precedence and tied to factors such as what marketplace, and what is role of filer (e.g., buyer, seller).

FIG. 31, FIG. 32, FIG. 33 and FIG. 34 are screenshots illustrating another customized online dispute resolution process based on entering from a sub-marketplace of the marketplace involving real estate disputes that can further be tailored by type of user (e.g., REALTOR or buyer/seller). FIG. 35, FIG. 36, FIG. 37, FIG. 38, FIG. 39 and FIG. 40 are screenshots illustrating further aspects of filing and processing and online dispute resolution involving a sector of the marketplace involving real estate.

FIG. 41 is a screenshot illustrating a link to online dispute resolution system 10 specifically designed for feedback removal of a negative reputation rating in online marketplace 18. FIG. 42 is a screenshot illustrating an online process to initiate a specific reputation feedback dispute resolution process as linked from an online marketplace reputation system. FIG. 43 is a screenshot illustrating a direct link to a specific reputation feedback dispute resolution process from a dispute resolution entry in an online marketplace. FIG. 44 is a screenshot illustrating a negative feedback notification. FIG. 45 is a screenshot illustrating an identification of a feedback related dispute. Entry into a dispute resolution can be accomplished from an online payment process system, such as PayPal™.

Note that the specific online dispute resolution process utilized, including communications utilized in the dispute resolution process, can be dependent not only on the type of dispute and/or the sector of marketplace 18 but also on the “point of entry” into the dispute resolution process. As used herein, the term “point of entry” refers to the particular the process or sector, i.e., “sub-marketplace” of online marketplace 18 or verification and compliance system 16 from which the ODR process is initiated. For example, the ODR process may be initiated from a real estate sub-marketplace, a travel sub-marketplace, a motors sub-marketplace, and the like. As another example, the ODR process may be initiated during a process for certification for a seal of approval by verification and compliance system 16. As another example, point of entry may be from a description of commercial policies of one of the one or more parties which may also be included in a post purchase communication email or other message. As another example, the point of entry may be an online payment process, a reputation management process, or a feedback reputation correction process provided by online marketplace 18.

FIG. 46 is a screenshot of a specialized seal displayed on a sub-marketplace of online marketplace 18, which may have a plurality of sub-marketplaces. In this example, verification and compliance system 16 generates specialized electronic seals for display within a motors sub-marketplace, and illustrates specific commitments made by the participants and that leads to a specialized online dispute resolution process for the motors sub-marketplace. The seal is dynamically displayed on a seal member's motors listings if the member is performing within acceptable standards set by compliance and verification system 16. The seal clarifies seller-specific and sub-marketplace specific guarantees (commitments) that can be disputed through specialized online dispute resolution processes of ODR system 10.

The specialized ODR process can be accessed and/or initiated by clicking on a seal or elsewhere in the sub-marketplace. When initiated, case routing module 32 routes the case to the particular dispute resolution module that is tailored to handle the dispute based on a number of factors relating to the sub-marketplace, its participants, and their commitments.

FIG. 47, FIG. 48 and FIG. 49 are screenshots illustrating links to online dispute resolution system 10 from online marketplace 18 and tying online dispute resolution to trust and safety in that marketplace. FIG. 50 is a screenshot illustrating a link to access online dispute resolution system 10 through a listing in online marketplace 18 or on a website in conjunction with delivery of media object representative of a seal of certification and selling practices and policies associated with such media object and seal of certification. FIG. 51 is a screenshot illustrating a direct link to online dispute resolution system 10 from an online entity's profile page on through such media object and seal of certification. FIG. 52 is a screenshot illustrating a direct link to online dispute resolution system 10 involving negative feedback removal from a negative feedback rating notification message.

FIG. 53 is a screenshot illustrating a non-response electronic message. A non-response electronic message can be sent, for example, during a reputation feedback removal process. If the creator of negative feedback does not respond to a reputation feedback dispute initiated by the party who received the negative feedback, this electronic message can be sent to the initiator of the feedback dispute keeping the user informed of the progress of the case and also provides the initiator the ability to close the case if the problem has been successfully resolved.

FIG. 54 is a screenshot illustrating another automated response electronic message also in conjunction with a negative feedback removal dispute. In this case, it has been determined that the respondent (the creator of the negative feedback) has not responded within the allotted time. This message notifies the initiator of the negative feedback removal dispute that negative feedback is now eligible for removal. This is an example of automated communications which are tailored to specific dispute resolution processes, specific disputes and/or specific sectors of the marketplace.

FIG. 55 is a screenshot illustrating another automated electronic message in conjunction with a negative feedback removal dispute. This message notifies the would-be responder (the creator of the negative feedback) that this is the third notice of the dispute and highlights that continued non-response can lead to removal of the negative feedback.

FIG. 56 is a screenshot illustrating a “frequently asked questions” page which encourages participation in the online dispute resolution process and builds authority of users and potential users of system 10.

FIG. 57 is a screenshot illustrating a screen which can be used to obtain the commitment of a party to a certain dispute resolution mode, e.g., mediation, which can occur before the other party to the dispute commits to or is charged for that dispute resolution mode.

FIG. 58 is a screenshot illustrating an interface for centralized administration of dispute resolution specialists.

FIG. 59 is a screenshot illustrating an interface for centralized administration of dispute resolution specialist giving administrators the ability to define groups of dispute resolution cases and the ability to direct a case volume of dispute resolution cases to a dispute resolution specialist or group of specialists.

FIG. 60 is a screenshot illustrating an interface for a dispute resolution administrator providing the administrator with the ability to route a dispute resolution case to a specific dispute resolution specialist or group of dispute resolution specialists.

FIG. 61 is a screenshot illustrating an interface for a dispute resolution specialist or dispute resolution administrator to prioritize and/or sort dispute resolution cases in order to manage high volumes of concurrent cases.

FIG. 62 illustrates a process for displaying online entity selling practices which helps avoid dispute or provides an easy access to the ODR system 10. From the seal member services area (450), an online entity links to policy definition tools (470). There the online entity defines (472) the online marketplace or sector of an online marketplace for which a selling practice, or selling practices, of the online entity is to be displayed. The online entity further determines how the policies will be displayed (473) with options that can include display in an online marketplace listing, or in an automated email to a winning bidder on an online marketplace. The online entity customizes (474) its selling practices or policies, or uses an online wizard (making a series of online selections) to choose selling practices or policies. The policies or practices are defined by category (476) such as payments, delivery, refunds and returns, contact information, fees or other information. The online entity is allowed to view samples (480) specific to the online marketplace or a particular sector of an online marketplace. When completed, the seal member profile database 38 is updated and the online entity is allowed to preview (478) the functionality of the selling practices or policies selected. Policies can be viewed through multiple display functionality 434 as defined in 473. The online entity may also choose to have the policies automatically displayed on new listings in an online marketplace 486, or automatically e-mail (488) such policies to a bidder, winning bidder or buyer. The entity can also define what is displayed when a user clicks on the seal (484).

FIG. 63, FIG. 64, FIG. 65 and FIG. 66 are screenshots illustrating policy or selling practice definition for an online entity, including a selling policy or practice creation tool using a wizard. FIG. 67 is a screenshot illustrating display of selling policies or selling practices of an online entity in the automotive sector of an online marketplace. FIG. 68 is a screenshot illustrating a click through to enable display of selling policy or selling practice details and easy access to online dispute resolution system 10. FIG. 69 is a sample winning bidder email automatically sent to the winning bidder in an online marketplace, which reminds them of a seal members commitments and provides the winner with a link to the seal members profile page, with access to file an online dispute.

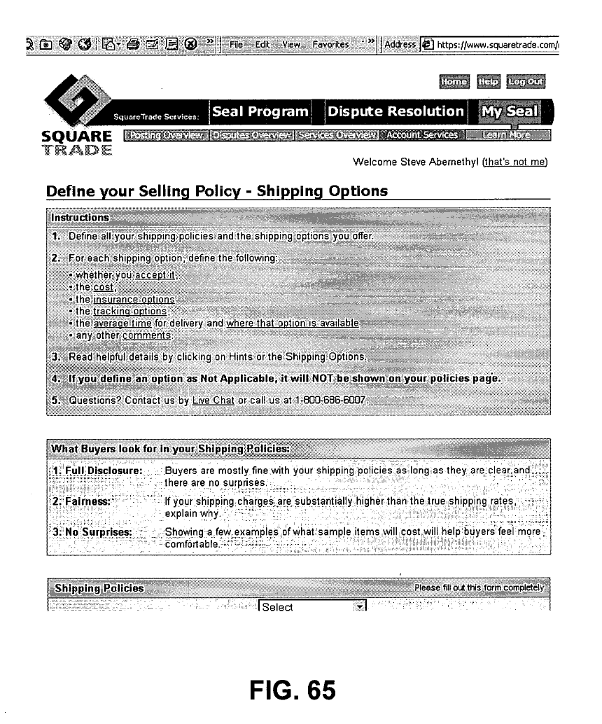

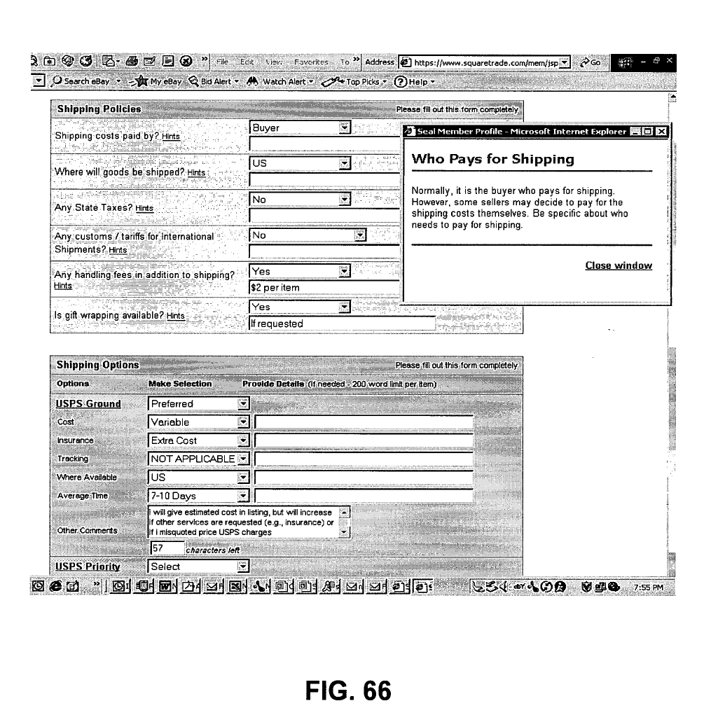

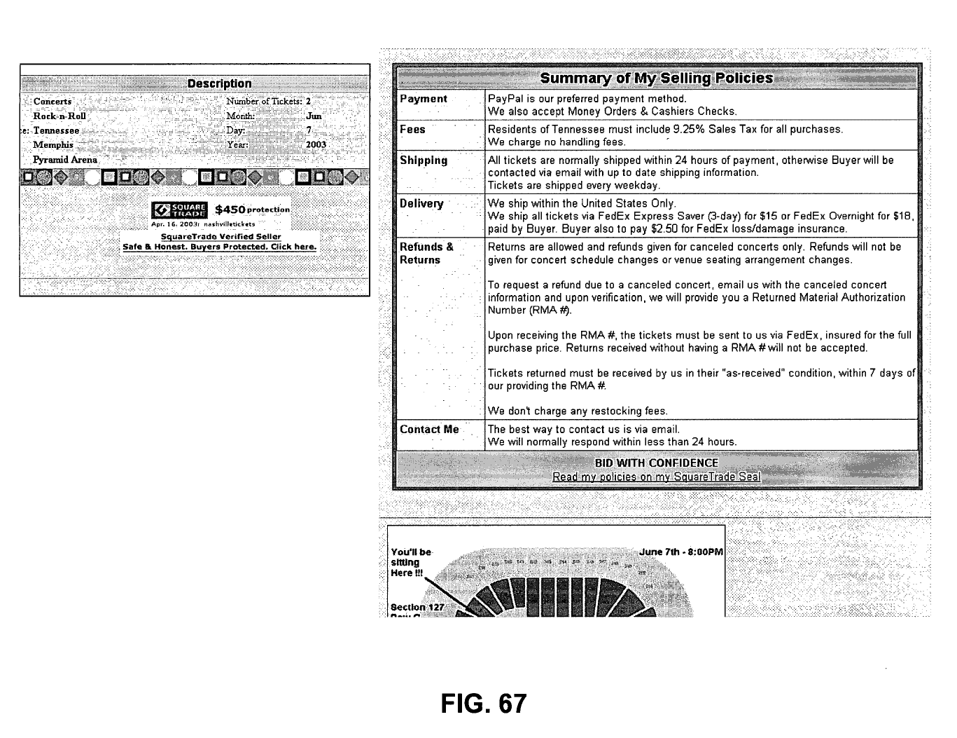

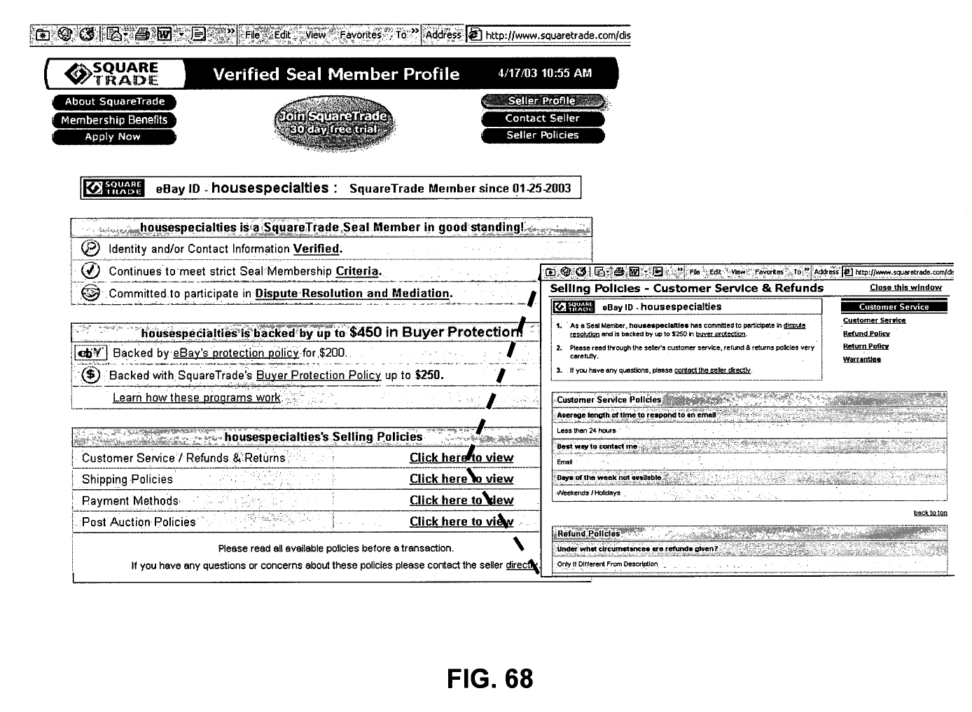

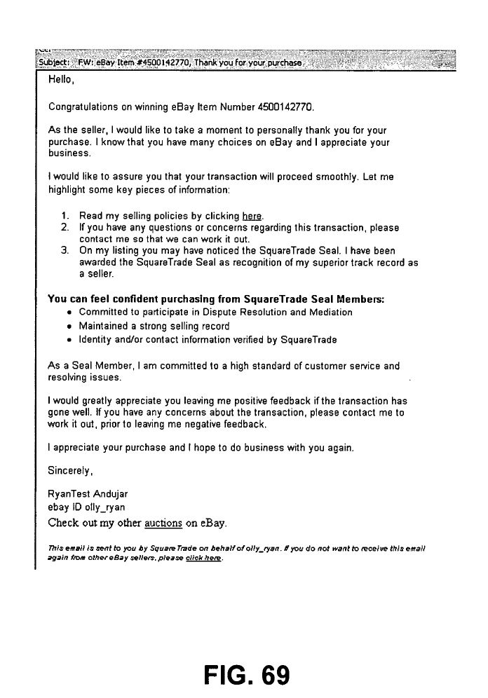

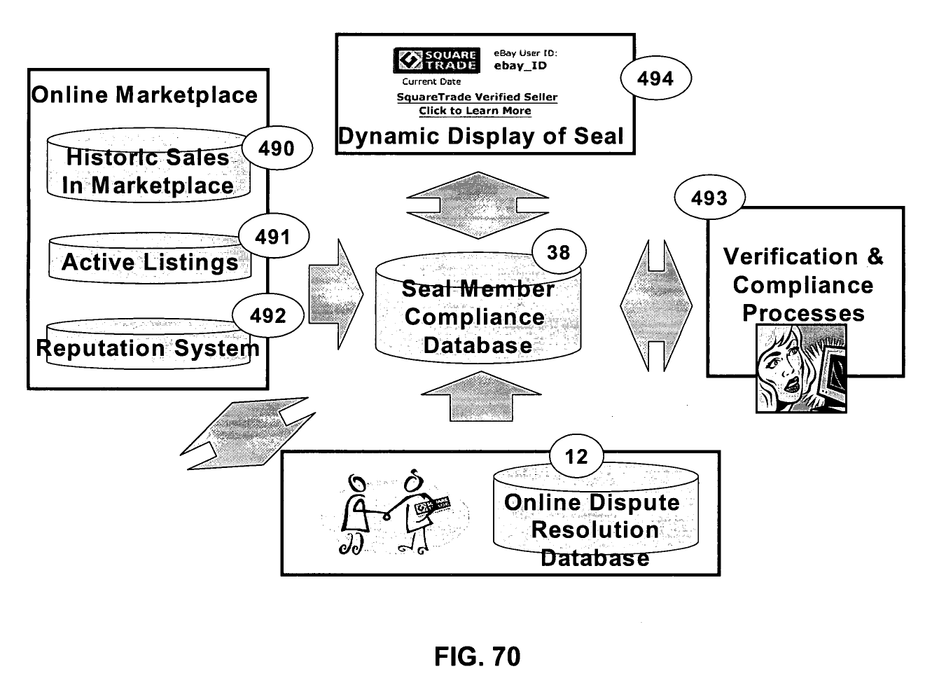

FIG. 70 is an overview of integrated systems supporting compliance verification in online marketplace 18 including seal member compliance database 17, a dynamic media object representing a seal certification 494, verification in compliance processes 493, an online dispute resolution database 12 and information access to historical sales data 490, active listings 491 and reputation system 492.

Various modifications and alterations of this invention will be apparent to those skilled in the art without departing from the scope and spirit of this invention. It should be understood that this invention is not limited to the illustrative embodiments set forth above.

1. A method comprising:
receiving information about the dispute in one of a plurality of sub-markets of an online marketplace involving one or more parties;
determining a proposed resolution of the dispute based at least in part on the one of the plurality of sub-markets of the online marketplace; and
presenting the proposed resolution to the one or more parties.

2. The method of claim 1 wherein the one of the plurality of sub-markets of the online marketplace comprises one of an automotive sub-market, a travel sub-market, electronics and a real estate sub-market.

3. A system comprising:
a dispute database configured to store information about a dispute in one of a plurality of sub-markets of an online marketplace;
an application server operatively coupled to the dispute database to identify the sub-market of the online marketplace in which the dispute occurred, and to present one or more proposed resolutions for the dispute based at least in part on the identified sub-market; and
a web server operatively coupled to the application server and adapted to deliver the proposed resolution to a device for presentment to the one or more parties.

4 The system of claim 3, wherein the application server aids the parties in identifying issues related to the dispute.

5. A system of claim 3 wherein the one of the plurality of sub-markets of the online marketplace comprises one of an automotive sub-market, a travel sub-market, an electronics sub-market and a real estate sub-market.

6. A method comprising:
receiving information about a dispute for a transaction involving one or more parties in one of a plurality of sub-markets of an online marketplace;
identifying an issue involved in the dispute over the transaction;
identifying the sub-marketplace of the plurality of sub-marketplaces of the online marketplace in which the dispute occurred;
identifying one or more proposed resolution suggestions to the issue involved in the dispute based at least in part on the identified sub-marketplace; and
presenting the proposed resolution to the one or more parties.

7. The method of claim 6, wherein the one of the plurality of sub-marketplaces of the online marketplace comprises one of an automotive sub-marketplace, a travel sub-marketplace, an electronics sub-marketplace and a real estate sub-marketplace.

8. The method of claim 6, wherein identifying one or more proposed resolution suggestions comprises identifying one or more proposed resolution suggestions based upon at least one of (i) the parties involved in the dispute, (ii) the parties' respective commitments, (iii) the parties' historic activity in the online marketplace, and (iv) the parties' historic use of the online dispute resolution system.

9. A method comprising:
receiving case information about an online dispute involving one or more parties;
identifying a point of entry from which an online dispute resolution (ODR) process was initiated;
determining one or more proposed resolutions for the dispute based at least in part on the point of entry; and
presenting the proposed resolutions to the parties.

10. The method of claim 11, wherein identifying a point of entry comprises identifying one of a plurality of sub-marketplaces of an online marketplace from which the ODR process was initiated, and wherein determining one or more proposed resolutions comprises applying ODR processes specific to the identified sub-marketplace to determine the proposed resolutions.

11. The method of claim 10, further comprising routing the received case information to a specialized ODR software module provided by an ODR system based on the identified sub-marketplace, wherein the specialized ODR software module applies the ODR processes specific to the identified sub-marketplace.

12. The method of claim 10, wherein determining one or more proposed resolutions further comprises determining the proposed resolutions based upon at least one of
(i) the parties involved in the dispute, (ii) the parties' respective commitments, (iii) the parties' historic activity in the online marketplace, and (iv) the parties' historic use of the online dispute resolution system.

13. The method of claim 10, wherein identifying a point of entry comprises identifying the point of entry as a process for rating a reputation of a participant of an online marketplace, and wherein determining one or more proposed resolutions comprises applying ODR processes to automatically correct the reputation of the participant within the online marketplace.

14. The method of claim 13, wherein the participant comprises one of a buyer or a seller involved in a transaction within the marketplace.

15. The method of claim 10, wherein identifying a point of entry comprises identifying the point of entry as a process for certification for a seal of approval issued by a verification and compliance system, and wherein determining one or more proposed resolutions comprises applying customized ODR processes for resolving the dispute based on commitments made by one or more of the parties as indicated by the seal.

16. The method of claim 10, wherein the point of entry is from a description of commercial policies of one of the one or more parties which is included in a post-purchase communication.

17. The method of claim 10 wherein the point of entry is from one of (i) a reputation management system, (ii) a feedback reputation correction system, (iii) a notification regarding a potential reputation correction process, and (iv) an online payment process.

18. A online dispute resolution system comprising:
a dispute database configured to store information about a dispute in an online marketplace involving one or more parties; and
an application server operatively coupled to the dispute database, wherein the application server determines a point of entry from which an online dispute resolution (ODR) process for the dispute was initiated, and generates a proposed resolution for the dispute based at least in part on the determined point of entry.

19. The online dispute resolution system of claim 18, wherein the online marketplace comprises a plurality of sub-marketplaces, and the application server determines the point of entry as one of the plurality of sub-marketplaces from which the ODR process was initiated, and applies ODR processes specific to the identified sub-marketplace to determine the proposed resolution.

20. The online dispute resolution system of claim 19, further comprising a set of ODR modules executing on the application server, wherein each of the ODR modules corresponds to a respective one of the sub-marketplaces and provides an ODR process specific to the respective sub-marketplace.

21. The online dispute resolution system of claim 20, further comprising a case routing module executing on the application server that routes the received case information to one of the set of ODR modules based on the sub-marketplace identified as the point of entry.

22. The online dispute resolution system of claim 18, wherein the online marketplace provides a process for updating a reputation of a participant in the marketplace, and wherein the application server determines the point of entry as the process for updating the reputation, and automatically updates the reputation of the participant within the online marketplace based on an outcome of the ODR process.

23. The online dispute resolution system of claim 22, further comprising a communication module executing on the application server to update a reputation database of the online marketplace.

24. The system of claim 18, further comprising:
a communication module executing on the application server to communicate with a compliance and verification system that certifies the parties as members of the marketplace and issues electronic seals of approval to the parties prior to the dispute for display within the online marketplace as an indication of pre-commitments made by the parties, and
wherein the application server determines the point of entry as from the compliance and verification system, and applies a customized ODR process for resolving the dispute based on the pre-commitments made by the parties.

25. The system of claim 24, further comprising a seal member module executing on the application server, wherein the seal member module provides customized messaging throughout the customized ODR process to acknowledge the pre-commitments of the parties as seal members that have been certified by the compliance and verification system.

26. The system of claim 24, further compliance a compliance escalation module executing on the application server that update a compliance database of the verification and compliance systems throughout the customized ODR process.

27. The system of claim 24, further comprising a web server operatively coupled to the application server to deliver the proposed resolution to a device for presentment to the parties.

28. A method comprising:
receiving in an online dispute resolution (ODR) system case information about an dispute involving one or more parties associated with a transaction in an online marketplace;
remotely accessing a database of the online marketplace to automatically verify the received information; and
processing the dispute in accordance with the verification.

29. The method of claim 28, wherein remotely accessing a database comprises remotely accessing a database of the online marketplace to automatically verify attributes of at least one of the parties.

30. The method of claim 28, wherein remotely accessing a database comprises remotely accessing a database of the online marketplace to automatically verify attributes of an issue involved in the dispute.

31. The method of claim 28, wherein remotely accessing a database comprises remotely accessing a database of the online marketplace to automatically verify attributes associated with the transaction in the marketplace.

32. The method of claim 28, further comprising automatically verify the received information by remotely accessing a database of a compliance and verification system that issued an electronic seal of certification to at least one of the parties.

33. An online dispute resolution system comprising:
a communication module to receive case information about an dispute involving one or more parties associated with an electronic commerce transaction in an online marketplace;
a marketplace verification module that remotely accesses a database of the online marketplace to automatically verify the received information; and
a dispute resolution engine that identifies one or more potential resolutions for the dispute based at least in part on the verification.

34. The online dispute resolution of claim 33, wherein the marketplace verification module accesses the database of the online marketplace to verify attributes associated with one or more of the parties.

35. The online dispute resolution claim 33, wherein the marketplace verification module accesses the database of the online marketplace to verify an issue involved in the dispute.

36. The online dispute resolution claim 33, wherein the marketplace verification module accesses the database of the online marketplace to verify attributes associated with the electronic commerce transaction in the online marketplace.

37. The online dispute resolution claim 33, further comprising an application server, and wherein the communication module, the marketplace verification module, and the dispute resolution engine comprise software modules executing on the application server.

38. The online dispute resolution claim 33 further comprising a web server operatively coupled to the application server capable of delivering the resolution to a device for presentment to the one or more parties.

39. A method comprising:
receiving case information about an online dispute two or more parties involved in an electronic commerce transaction;
identifying at least one attribute of the parties and at least one issue involved in the dispute;
routing the case information to one of a set of dispute resolution modules executing within an online dispute resolution (ODR) system based at least in part on the identified attribute and the identified issue, wherein each of the dispute resolution modules define a specific ODR process for resolving the dispute;
applying the ODR process defined by the dispute resolution module to which the case information was routed to determine one or more proposed resolutions for the dispute; and
presenting the proposed resolutions to the parties.

40. The method of claim 39, wherein identifying at least one issue comprises identifying a type of a transaction involved in the dispute.

41. The method of claim 39, wherein identifying at least one issue comprises identifying which one of a plurality of sub-marketplaces of the online marketplace the dispute arises.

42. The method of claim 39, further comprising routing the case information to an insurance company when the specific ODR process applied by the dispute resolution modules fail to resolve the dispute

43. The method of claim 39, wherein routing the case information comprises routing the case information to a direct negotiation module that facilitates direct negotiations between the parties.

44. The method of claim 39, wherein routing the case information comprises routing the case information to a fraud claims module to apply a specific ODR process when one the parties alleges fraud or when the identified issue indicates that fraud may be involved.

45. The method of claim 39, wherein routing the case information comprises routing the case information to a general mediation module to allow intervention by an online dispute resolution specialist.

46. The method of claim 39, wherein further comprising routing the case information to an online payment system upon resolution of the dispute.

47. An online dispute resolution system comprising:
a communication module to receive case information about a dispute involving parties associated with an electronic commerce transaction in an online marketplace;
an issue identification module that identifies at least one issue associated with the dispute;
a plurality of dispute resolution modules configured to apply a set of different ODR processes to generate a proposed resolution to the dispute; and a case routing module that routes the received case information to one of the set of ODR modules based on the identified issue.

48. The online dispute resolution system of claim 47, wherein the plurality of dispute resolution modules includes a direct negotiation module that facilitates direct negotiations between the parties.

49. The online dispute resolution system of claim 47, wherein the plurality of dispute resolution modules includes a fraud claims module to apply a specific ODR process when one the parties alleges fraud or when the identified issue indicates that fraud may be involved.

50. The online dispute resolution system of claim 47, wherein the plurality of dispute resolution modules includes a general mediation module to allow intervention by an online dispute resolution specialist.

51 The online dispute resolution system of claim 47, further comprising a negative reputation notification (NRN) module that monitors a reputation system of the marketplace to identify any recently posted negative reputation ratings.

52 The online dispute resolution system of claim 51, wherein the NRN module issues a message to a party with which the negative reputation ratings is associated, wherein the message includes a link to the online dispute resolution system.

53. The online dispute resolution system of claim 47, further comprising a marketplace verification module that accesses the online marketplace and automatically verifies at least a portion of the case information.

54. The online dispute resolution system of claim 47, wherein the plurality of dispute resolution modules includes a reputation correction module that, based on an outcome of the ODR process, automatically updates a reputation system of the online marketplace to correct reputation feedback for at least one of the parties.

55. The online dispute resolution system of claim 47, further comprising a communication module to provide an application programming interface for communicating with the reputation system of the online marketplace.

56. A method comprising:
receiving case information at an online dispute information system, wherein the case information describes an online dispute involving one or more parties;
determining a proposed resolution of the dispute; and
issuing a communication to a reputation rating system of an online marketplace, wherein the communication directs the reputation rating system to update a reputation rating of at least one of the parties as a function of the resolution.

57. The method of claim 56, further comprising the step of automatically routing the dispute to one of an automated process and a dispute resolution specialist.

58. The method of claim 57, wherein the automatically routing step is dependent upon a type of dispute.

59. The method of claim 56, further comprising the step of automatically notifying the online marketplace of the dispute resolution.

60. The method of claim 56, further comprising the step of automatically notifying the online marketplace if at least one of the one or more parties fails to respond to a notification related to the method.

61. The method of claim 56, further comprising the step of automatically collecting payment for the method, wherein the payment is dependent upon a type of the dispute.

62. The method of claim 56, wherein the reputation rating is positively impacted as a result of a successful resolution of the dispute, and issuing a communication comprises issuing a communication directing the reputation system to remove a negative feedback associated with the affected one of the parties.

63. The method of claim 56, wherein the reputation rating is positively impacted by completion of resolution of the dispute.

64. The method of claim 56, wherein reputation rating is negatively impacted by a failure of one or more of the parties to complete resolution of the dispute, and
issuing a communication comprises issuing a communication informing the reputation system of the failure of the one or more parties to complete resolution of the dispute.

65. The method of claim 51 wherein the reputation rating is negatively impacted by a failure of one of the one or more parties to accept the proposed resolution, and
issuing a communication comprises issuing a communication informing the reputation system of the failure of the one or more parties to accept the proposed resolution.

66. A system of resolving a dispute in one of a plurality of sectors of an online marketplace involving one or more parties, comprising:
a dispute database configured to store information about the dispute; and
an application server operatively coupled to the dispute database adapted to determine a proposed resolution of the dispute and automatically communicate to a third party reputation rating system to modify a reputation of at least one of the parties as a function of the resolution.

67. A system of claim 66 further comprising a web server operatively coupled to the application server capable of delivering the proposed resolution to a device for presentment to the one or more parties.

68. A system of claim 66 wherein the reputation rating is positively impacted as a result of a successful resolution of the dispute.

69. A system of claim 66 wherein the reputation rating is positively impacted by completion of resolution of the dispute.

70. A system of claim 66 wherein reputation rating is negatively impacted by a failure of one of the one or more parties to complete resolution of the dispute.

71. A system of claim 66 wherein the reputation rating is negatively impacted by a failure of one of the one or more parties to accept the proposed resolution.

72. A method of automatically updating a reputation rating of a first user of an online marketplace in which a second user provides feedback relative to the reputation rating of the first user, the method comprising the steps of:
monitoring the online marketplace to detect the feedback provided by the second user; and
issuing a communication to automatically notify the first user of negative feedback from the second user, wherein the communication invites the first user to enter an online dispute resolution process to resolve a dispute on which the feedback is based at least.

73. The method of claim 73, further comprising applying the online dispute resolution process to determine a proposed resolution for the dispute.

74. The method of claim 73, further comprising accessing a reputation system of the online marketplace to automatically correct the feedback based on the resolution.

75. The method of claim 73, further comprising issuing a communication to a reputation system of the online marketplace, wherein the communication directs the reputation system to automatically correct the feedback based on the resolution.

76. The method of claim 73 further comprising the step of accessing the reputation system of the online marketplace to confirm that the feedback has been updated in the online marketplace.

77. The method of claim 72, further comprising applying a set of rules to determine whether to issue the communication.

78. The method of claim 77, wherein applying a set of rules determining if the feedback is too old to be challenged.

79. A method of resolving a dispute in an online marketplace involving one or more parties, comprising the steps of:
receiving a commitment for payment for the electronic dispute resolution process from the one or more parties involved in the dispute;
receiving information about the dispute from the one or more parties who have committed to the payment;
receiving payment from the one or more parties who have committed to the payment;
determining a proposed resolution the dispute; and
presenting the proposed resolution to the one or more parties.

80. A method of resolving a dispute in an online marketplace involving one or more parties, comprising the steps of:
receiving information about the dispute;
determining a time for payment for an electronic dispute resolution process as a function of an attribute of the dispute;
receiving payment for the electronic dispute resolution process;
determining a proposed resolution the dispute; and
presenting the proposed resolution to the one or more parties.

81. The method of claim 80 wherein the attribute comprises a sector of the online marketplace having a plurality of sectors in which the dispute arises.

82. The method of claim 80 wherein the attribute comprises a value of the dispute.

83. The method of claim 80 wherein the time for payment is selected based upon an increased likelihood of effective resolution of the dispute in the electronic dispute resolution process.

84. The method of claim 80 wherein the time for payment is selected based upon a likelihood of manual intervention during the electronic dispute resolution process.

85. The method of claim 80 wherein the time for payment is based upon which of a plurality of processes have occurred.

86. The method of claim 85 wherein the plurality of processes comprises approvals.

87. The method of claim 80 further comprising the step of determining from which of the one or more parties is responsible for the payment.

88. A method of administering an online dispute resolution process involving a plurality of disputes, each of the plurality of disputes involving one or more parties, the method comprising the steps of:
receiving information about the dispute and the involved parties;
automatically prioritizing the plurality of disputes for handling by a dispute resolution specialist;
presenting an interface that visually highlights key attributes of the disputes to assist the dispute resolution specialists in providing tailored processes based on the attributes;
visually displaying alerts if cases are not handled according to parameters defined, where alerts can be sent also by email to specialists and specialist administrators; and
displaying the plurality of disputes to the dispute resolution specialist based on the prioritization.

89. The method of claim 88, wherein the attributes comprises membership in a compliance and verification system.

90. The method of claim 88, wherein the attributes comprises pre-commitments by the parties.

91. The method of claim 88, wherein the attributes comprises one or more of types of issues present within the disputes, types of the parties involved in the disputes, sales activity, and repeat use of an online dispute resolution system.

92. The method of claim 88 further comprising the step of filtering the plurality of disputes which are displayed to the dispute resolution specialist based upon a filter.

93. The method of claim 92 wherein the filter is based on at least one of an age of each of the plurality of disputes, a length of time since last action of each of the plurality of disputes, and a status of each of the plurality of disputes.

94. The method of claim 88 further comprising present an interface by which a dispute resolution specialist administrator assigns one or more of the plurality of disputes to a different dispute resolution specialist.

95. The method of claim 94, further comprising maintaining data that defines pools of the dispute resolution specialists, wherein presenting an interface comprises presenting an interface by which the dispute resolution specialist administrator can assign the disputes to the pools of dispute resolution specialists.

96. The method of claim 95, further comprising presenting the interface to permit the dispute resolution specialist administrator to task the pools of dispute resolution specialists with respective requirements for responding to the parties, including speed and specific messaging requirements.

97. The method of claim 95, further comprising automatically routing the disputes to the pools of dispute resolution specialists based on factors of the disputes, including issue types, party attributes, marketplace locations, and value of disputes.

98. The method of claim 95, further comprising issuing alerts to inform the dispute resolution specialist administrator when one or more of the pools approach a defined capacity of assigned disputes.

99. The method of claim 95, further comprising issuing alerts to inform the dispute resolution specialist administrator when a response time of one or more of the dispute to their respective assigned disputes drops below a defined response period.

100. The method of claim 95, further comprising presenting the interface to allows the dispute resolution administrators to view current and historic disputes based on attributes of the disputes.

101. The method of claim 100, wherein the attributes comprise at least one of an issue type, a party type, a resolution type, and a sub-marketplace type.

102. A method of resolving a dispute in electronic commerce involving one or more parties, comprising the steps of:
receiving information about the dispute;
obtaining a commitment by one of the parties to a particular form of dispute resolution;
communicating the commitment to the other parties;
obtaining a payment for the particular form of dispute resolution from the another of the one or more parties; and
conducting the particular form of dispute resolution upon obtaining the payment.

103. A method comprising:
accepting a commitment made by an online entity in an online marketplace to a selling practice;
delivering a media object to a device for presentment to a potential buyer in the online marketplace, the media object unique to the online entity and representative of seal of certification of the online entity to the commitment; and
applying an online dispute resolution process in accordance with the commitment to any dispute that arises between the online entity and the potential buyer in the online marketplace

104. The method of claim 103, wherein the selling practice comprises a set of terms of delivery.

105. The method of claim 103, wherein applying an online dispute resolution process comprises:
receiving information about the dispute in one of a plurality of sub-markets of the online marketplace;
determining a proposed resolution of the dispute based at least in part on the one of the plurality of sub-markets of the online marketplace; and
presenting the proposed resolution to the one or more parties.

106. The method of claim 105, further comprising
capturing selling practice information via an online form by the online entity; and
communicating the selling practice information in connection with delivering the media object to the device.
